(19) United States
(12) Patent Application Publication
(10) Pub. No.: US 2012/0236126 A1
(43) Pub. Date: Sep. 20, 2012

(54) IMAGE PICKUP DEVICE, IMAGE PICKUP METHOD, PROGRAM, AND INTEGRATED CIRCUIT

(76) Inventors: Kenjiro Tsuda, Kyoto (JP); Hiroaki Shimazaki, Tokyo (JP); Tatsuro Juri, Osaka (JP); Hiromichi Ono, Osaka (JP)

(21) Appl. No.: 13/512,809

(22) PCT Filed: Nov. 18, 2010
(86) PCT No.: PCT/JP2010/006780

§ 371 Date: May 30, 2012

(30) Foreign Application Priority Data
Jan. 13, 2010 (JP) 2010-004498

(51) Int. Cl. H04N 13/02; H04N 13/04

(52) U.S. Cl. 348/47; 348/50; 348/E13.074; 348/E13.075; 348/E13.008; 348/E13.014

(57) ABSTRACT

A conventional stereo image pickup device forms an appropriate stereo image by changing the stereo base in accordance with the distance to a subject, but fails to select an appropriate focal length or stereo base by simply using the subject distance without obtaining the subject size. A stereo image pickup device (1000) estimates the size of a subject in accordance with the imaging mode set in a typical two-dimensional camera, and estimates the subject distance using the estimated size of the subject and the focal length, and further calculates the stereo base that enables an optimum disparity to be achieved using the subject distance, determines the stereo base, and aligns the two imaging units (the first imaging unit (103) and the second imaging unit (104)). As a result, the stereo image pickup device forms a stereo image having an appropriate stereoscopic effect.

### RELATED APPLICATIONS

This application is the U.S. National Phase under 35 U.S.C. §371 of International Application No. PCT/JP2010/006780, filed on Nov. 18, 2010, which in turn claims the benefit of Japanese Application No. 2010-004498, filed on Jan. 13, 2010, the disclosures of which Applications are incorporated by reference herein.

### TECHNICAL FIELD

The present invention relates to an image pickup device (a stereo image pickup device) that forms a right eye image and a left eye image for stereoscopic viewing, a method for obtaining a stereo image, a program, and an integrated circuit.

### BACKGROUND ART

Conventional stereo cameras (stereo image pickup devices) commonly set the distance between the right eye camera and the left eye camera (called the stereo base) to a fixed distance corresponding to an average human eye distance of about 6.5 to 7 cm. Such a camera may produce a poor stereoscopic effect when imaging a scene including a distant subject. When imaging a scene including a near subject, the camera may form a stereo image that is difficult to view three dimensionally as it can have a large binocular disparity or it can capture the subject only in one of the right eye image and the left eye image.

FIGS. 2A and 2B are diagrams describing the relationship between the subject distance and the disparity for a scene including a near subject. FIGS. 3A and 3B are diagrams describing the relationship between the subject distance and the disparity for a scene including a distant subject.

FIG. 2A is a diagram describing the relationship between the subject distance and the disparity when the subject distance is short, whereas FIG. 2B is a diagram describing the relationship between the subject distance and the disparity when the subject distance is long.

As shown in FIGS. 2A and 2B, the disparity on the virtual screen is larger when the subject distance is short than when the subject distance is long. At the short subject distance, the image pickup device forms a stereo image with the binocular disparity being large. The resulting stereo image displayed on a display device would have a large disparity on the display screen (the left eye image and the right eye image would be largely misaligned with each other on the screen). Such a stereo image would be difficult to view three-dimensionally by a viewer.

FIGS. 3A and 3B are drawings describing the relationship between the subject distance and the disparity. FIG. 3A is a diagram describing the relationship when the subject distance is short, whereas FIG. 3B is a diagram describing the relationship when the subject distance is long.

More specifically, FIGS. 3A and 3B are diagrams each describing the stereoscopic effect of a stereo image depending on the disparity on the virtual screen when two subject points in the image has a different disparity. As shown in FIGS. 3A and 3B, the disparity difference between the two subject points is large when their subject distances are short. A stereo image (a three-dimensional image) formed with the disparity difference being large is less likely to have a poor stereoscopic effect. The disparity difference between the two subject points is small when their subject distances are long. A stereo image (a three-dimensional image) formed with the disparity difference being small can have a poor stereoscopic effect.

Considering this, the conventional stereo image pickup devices change the distance between a right point for forming a right eye image and a left point for forming a left eye image (in other words, the stereo base) in accordance with a scene to be imaged. The image pickup devices set the stereo base short when imaging a scene including a near subject, and set the stereo base long when imaging a scene including a distant subject. As a result, the conventional stereo image pickup devices can form stereo images for various scenes including scenes of near subjects and scenes of distant subjects. For a scene of a near subject, the conventional stereo image pickup devices can form a stereo image that can be fused by the right eye and the left eye. For example, Patent Literature 1 describes a method for forming a stereo image through processing similar to the processing described above and a display device for displaying the stereo image.

Setting the stereo base in an optimum manner in accordance with the subject distance will now be described.

FIGS. 4A and 4B are diagrams describing the optimum setting of the stereo base in accordance with the subject distance, which is also described in the above conventional example (Patent Literature 1).

FIG. 4A is a diagram describing the optimum setting of the stereo base in accordance with the subject distance in a near subject scene, whereas FIG. 4B is a diagram describing the optimum setting of the stereo base in accordance with the subject distance in a distant subject scene.

In FIG. 4A, the stereo base is set short to reduce the disparity on the virtual screen. In FIG. 4B, the stereo base is set long to increase the disparity difference between the two subject points on the virtual screen. In the example shown in FIG. 4B, the disparity difference between the two subject points is set large. This setting enables the resulting stereo image to have an enhanced stereoscopic effect.

With the above conventional technique (the conventional technique described in Patent Literature 1), image data for the right and left eyes (stereo image data) is generated in accordance with a predetermined plot. The plot can be created freely as necessary. Assuming that image data for various scenes including near subject scenes and distant subject scenes is to be generated in accordance with a plot created in advance, the operation for setting the stereo base with the conventional technique will now be described.

FIG. 17 is a flowchart showing the operation for setting the stereo base with the conventional technique.

Although the operation shown in FIG. 17 includes the processing for setting the stereo base d based on the size of a viewer, this processing in steps S16 and S18 is not pertinent to the invention, and will not be described.

When the image data generation is started, the plot corresponding to this imaging is interpreted (step S10).

The image pickup device determines whether the stereo base d needs to be set in accordance with the subject distance in the scene using the interpreted plot (step S12). When determining that the stereo base needs to be set, the image pickup device subsequently sets the stereo base d in step S14. When determining that the stereo base does not need to be set in step S12, the image pickup device further determines whether the stereo base d needs to be set in accordance with the size of the viewer using the interpreted plot (S16).

This operation for setting the stereo base is repeated until the image data generation is completed. When determining that the image data generation has been completed (step S20), the image pickup device ends its stereo base setting operation.

FIG. 18 shows an example of the stereo base setting performed in step S14.

The image pickup device first determines whether a point in the next scene is at a long distance, whether the point is within a range of normal distances, and whether the point is at a short distance (step S30, S32, and S34). When determining that the point is at a long distance, the image pickup device sets the stereo base d to a value greater than a reference distance ds (step S36). When determining that the point is in the normal distance range, the image pickup device sets the stereo base d to the reference distance ds (step S38). When determining that the point is at a short distance, the image pickup device sets the stereo base d to a value smaller than the reference distance ds (step S40). The stereo base d may be changed continuously or in stages in accordance with the distance to the point. It is preferable that the stereo base d is changed continuously to eliminate strangeness that could be felt by a viewer.

As described above, the stereo base d is set with the conventional technique to an optimum value in accordance with the subject distance in the scene.

The conventional technique can change the stereo base in accordance with the predetermined plot, and enables a stereo image to be formed (obtained) for various scenes including near subject scenes and distant subject scenes. The resulting (obtained) stereo image displayed on the device will be viewed by a viewer as a stereo image having a natural depth and an appropriate stereoscopic effect.

### CITATION LIST

### Patent Literature

Patent Literature 1: Japanese Unexamined Patent Publication No. H8-98212

### SUMMARY

### Technical Problem

The above literature describes the technique for adjusting the stereoscopic effect of a stereo image by setting, when a plot is set, the stereo base in accordance with the plot. When, however, imaging a live action for which no plot is set, the conventional technique described in the above literature would fail to set the stereo base and adjust the stereoscopic effect of the stereo image in an appropriate manner. The above literature also fails to describe any means for obtaining information about the distance to the subject, although the device needs such information about the subject distance to set the stereo base in an appropriate manner.

To overcome the above problems, it is an object of the present invention to provide a stereo image pickup device, a stereo image obtaining method, a program, and an integrated circuit with which the stereo base (the distance between a right point for obtaining a right eye image and a left point for obtaining a left eye image) in stereoscopic imaging is set in an appropriate manner in accordance with the imaging mode and a stereo image (a three-dimensional image) is formed in a manner to reproduce a natural stereoscopic effect (a natural depth) when the image is viewed.

### Solution to Problem

A first aspect of the present invention provides an image pickup device that forms a stereo image. The image pickup device includes an imaging unit, an obtaining unit, an estimation unit, and an adjustment unit.

The imaging unit images a subject and obtains a first point image corresponding to a scene including the subject viewed from a first point and a second point image corresponding to a scene including the subject viewed from a second point. The second point is different from the first point. The obtaining unit obtains subject size information indicating a size of the subject using information that is based on image data forming the first point image and the second point image or information that is based on settings used in forming the first point image and the second point image. The estimation unit estimates a subject distance, which is a distance from the image pickup device to the subject, using the subject size information. The adjustment unit adjusts an imaging parameter used by the imaging unit in a manner to change a disparity determined by the first point image and the second point image based on at least information indicating the subject distance estimated by the estimation unit.

This image pickup device sets the imaging parameter used in stereoscopic imaging (e.g., the stereo base (the distance between a right point for obtaining a right eye image and a left point for obtaining a left eye image) or the convergence angle) in an appropriate manner in accordance with information indicating the size of the subject obtained by the obtaining unit (by, for example, obtaining information indicating the size of the subject in accordance with the imaging mode), and obtains a stereo image (a three-dimensional image) that can reproduce a natural stereoscopic effect (a natural depth).

The subject distance refers to a distance from an object, from which light is focused onto the surface of the image sensor (e.g., the CCD image sensor or the CMOS image sensor) forming the imaging unit, to the camera (the image pickup device), and may also be an object point distance or a conjugate distance (an object-image distance). The subject distance may also be an approximate distance from the image pickup device to the subject, and may for example be (1) a distance from the gravity center of the entire lens of the optical system used in the image pickup device to the subject, (2) a distance from the imaging surface of the imaging unit to the subject, or (3) a distance from the gravity center (or the center) of the image pickup device to the subject.

A second aspect of the present invention provides the image pickup device of the first aspect of the present invention further including a setting unit and a storage unit.

The setting unit sets an imaging mode selected from a plurality of different imaging modes. The storage unit stores a plurality of sets of subject size information and the plurality of imaging modes in a manner that each set of subject size information indicating a size of a different subject corresponds to a different one of the imaging modes. The obtaining unit obtains, from the plurality of sets of subject size information stored in the storage unit, a set of subject size information corresponding to the imaging mode set by the setting unit.

In this image pickup device, the storage unit can store subject size information corresponding to a plurality of imaging modes (e.g., a portrait mode, a child mode, and a pet mode) (for example, subject size information indicating 1.6 m corresponding to the portrait mode, 1.0 m corresponding to the child mode, and 0.5 m corresponding to the pet mode), and the setting unit obtains subject size information corresponding to the currently set imaging mode. As a result, the image pickup device estimates the subject distance in an appropriate manner using the subject size determined (estimated) in accordance with the set imaging mode. The image pickup device then calculates the disparity for obtaining a natural stereo image using the estimated subject distance, and adjusts the imaging parameter (e.g., the stereo base or the convergence angle) used by the imaging unit based on the calculated disparity. This image pickup device obtains a natural stereo image using the adjusted imaging parameter of the imaging unit.

A third aspect of the present invention provides the image pickup device of the first or second aspect of the present invention further including a detection unit that detects an image area including the subject using at least one of the first point image and the second point image.

The obtaining unit obtains the subject size information based on information indicating the imaging area detected by the detection unit.

This image pickup device can obtain subject size information using information indicating an image area forming a predetermined subject included in the first point image or the second point image.

A fourth aspect of the present invention provides the image pickup device of the third aspect of the present invention in which the detection unit detects the image area including the subject by detecting an image area forming a face of a person.

This image pickup device can obtain subject size information using information indicating an image area forming a face of a person in the first point image or the second point image.

A fifth aspect of the present invention provides the image pickup device of one of the first to fourth aspects of the present invention in which the estimation unit estimates the subject distance based on information indicating a vertical size of the first point image and a vertical size of the second point image, information indicating a focal length used in forming the first point image and a focal length used in forming the second point image, and the subject size information.

A sixth aspect of the present invention provides the image pickup device of one of the first to fifth aspects of the present invention in which at least one of an initial focal length, an initial stereo base, and an initial convergence angle is used as the imaging parameter in accordance with the imaging mode set when the image pickup device is activated.

A seventh aspect of the present invention provides the image pickup device of one of the first to fifth aspects of the present invention in which the adjustment unit calculates a stereo base that corresponds to a target relative position determined by the first point and the second point by using the subject distance, a viewing distance that is a distance between a viewer and a display device for displaying the first point image and the second point image when the first point image and the second point image are viewed, and a target disparity set for the subject, and adjusts a stereo base of the imaging unit based on the calculated stereo base.

This image pickup device calculates the stereo base using the subject distance, the viewing distance, and the target disparity set for the subject, and determines the stereo base (the distance between a right point for obtaining a right eye image and a left point for obtaining a left eye image) based on the calculated stereo base.

As a result, the image pickup device forms a stereo image that has a natural stereoscopic effect using the adjusted imaging parameter of the imaging unit.

An eighth aspect of the present invention provides the image pickup device of the seventh aspect of the present invention further including a warning information display unit that displays warning information for a user when the stereo base of the imaging unit is not adjustable based on the stereo base calculated by the adjustment unit.

A ninth aspect of the present invention provides the image pickup device of the seventh or eighth aspect of the present invention further including an information providing unit that provides a user with information indicating the stereo base calculated by the adjustment unit.

A tenth aspect of the present invention provides the image pickup device of one of the seventh to ninth aspects of the present invention further including a display unit that provides a user with predetermined information.

The imaging unit includes a first imaging unit that obtains the first point image corresponding to the scene including the subject viewed from the first point and a second imaging unit that obtains the second point image corresponding to the scene including the subject viewed from the second point different from the first point.

The imaging unit performs imaging in a twin-lens imaging mode in which a stereo image is obtained using both the first imaging unit and the second imaging unit when the stereo base of the imaging unit is adjustable based on the stereo base calculated by the adjustment unit.

The imaging unit performs imaging in a double-shooting imaging mode in which a stereo image is obtained by performing imaging at least twice while the stereo image pickup device is being slid in a substantially horizontal direction when the stereo base of the imaging unit is not adjustable based on the stereo base calculated by the adjustment unit.

When the imaging unit performs imaging in the twin-lens imaging mode, the adjustment unit adjusts the imaging parameter based on the stereo base before a stereo image is obtained using the first point image and the second point image that are obtained by the first imaging unit and the second imaging unit. When the imaging unit performs imaging in the double-shooting imaging mode, the display unit performs a display urging the double-shooting imaging mode.

An eleventh aspect of the present invention provides the image pickup device of one of the first to sixth aspects of the present invention in which the adjustment unit calculates a convergence position that is a point of intersection between an optical axis of a first optical system and an optical axis of a second optical system by using the subject distance, a viewing distance that is a distance between a viewer and a display device for displaying the first point image and the second point image when the first point image and the second point image are viewed, and a target disparity set for the subject, and adjusts a convergence position of the imaging unit based on the calculated convergence position.

This image pickup device for example estimates the size of the subject (the subject size information) in accordance with the imaging mode, and then estimates the distance to the subject based on the estimated subject size. This image pickup device further calculates convergence position information (or the convergence angle) that enables an optimum disparity (for example a disparity falling within a stereoscopic-viewing enabling area that enables the first point image and the second point image to be fused into a stereo image of the subject when the first and second point images are viewed) to be achieved, and determines the convergence position (or the convergence angle) based on the calculated convergence position (or the calculated convergence angle). This image pickup device adjusts the position or the angle of the imaging unit in a manner to achieve the determined convergence position (or the convergence angle).

As a result, the image pickup device forms a stereo image that has a natural stereoscopic effect using the adjusted imaging parameter (the convergence position or the convergence angle) of the imaging unit.

A twelfth aspect of the present invention provides the image pickup device of the eleventh aspect of the present invention further including a warning information display unit that displays warning information for a user when the convergence position of the imaging unit is not adjustable based on the convergence position calculated by the adjustment unit.

A thirteenth aspect of the present invention provides the image pickup device of the eleventh or twelfth aspect of the present invention further including an information providing unit that provides a user with information indicating the convergence position calculated by the adjustment unit.

A fourteenth aspect of the present invention provides the image pickup device of the one of the seventh to thirteenth aspects of the present invention in which the adjustment unit sets, as the target disparity, a disparity defined in an area that enables the first point image and the second point image to be fused into a stereo image of the subject when the first point image and the second point image are viewed by a viewer.

This image pickup device sets the disparity to a value falling within the stereoscopic-viewing enabling area. In a stereo image obtained by this image pickup device, an image fusion position corresponding to the largest subject distance and an image fusion position corresponding to the smallest subject distance both fall within the stereoscopic-viewing enabling area in a reliable manner. This enables the image pickup device to form a stereo image having a more appropriate stereoscopic effect.

A fifteenth aspect of the present invention provides the image pickup device of one of the seventh to fourteenth aspects of the present invention further including an image recording unit that records the first point image and the second point image.

The image recording unit records the first point image and the second point image obtained by the imaging unit after the adjustment unit adjusts the imaging parameter.

In this image pickup device, the image recording unit can store a stereo image.

A sixteenth aspect of the present invention provides an image pickup method used by an image pickup device that forms a stereo image. The image pickup device includes an imaging unit that images a subject and obtains a first point image corresponding to a scene including the subject viewed from a first point and a second point image corresponding to a scene including the subject viewed from a second point different from the first point. The image pickup method includes an obtaining process, an estimation process, and an adjustment process.

In the obtaining process, subject size information indicating a size of the subject is obtained using information that is based on image data forming the first point image and the second point image or information that is based on settings used in forming the first point image and the second point image.

In the estimation process, a subject distance, which is a distance from the image pickup device to the subject, is obtained using the subject size information.

In the adjustment process, an imaging parameter used by the imaging unit is adjusted in a manner to change a disparity determined by the first point image and the second point image in accordance with at least information indicating the subject distance estimated by the step of estimating.

The image pickup method has the same advantageous effects as the image pickup device of the first aspect of the present invention.

A seventeenth aspect of the present invention provides a program that is executed by a computer to enable an image pickup device that forms a stereo image to implement an image pickup method. The image pickup device includes an imaging unit that images a subject and obtains a first point image corresponding to a scene including the subject viewed from a first point and a second point image corresponding to a scene including the subject viewed from a second point different from the first point. The image pickup method includes an obtaining process, an estimation process, and an adjustment process.

In the obtaining process, subject size information indicating a size of the subject is obtained using information that is based on image data forming the first point image and the second point image or information that is based on settings used in forming the first point image and the second point image.

In the estimation process, a subject distance, which is a distance from the image pickup device to the subject, is estimated using the subject size information.

In the adjustment process, an imaging parameter used by the imaging unit is adjusted in a manner to change a disparity determined by the first point image and the second point image in accordance with at least information indicating the subject distance estimated by the step of estimating.

The program executed by the computer to implement the image pickup method has the same advantageous effects as the image pickup device of the first aspect of the present invention.

An eighteenth aspect of the present invention provides an integrated circuit used in an image pickup device that forms a stereo image. The image pickup device includes an imaging unit that images a subject and obtains a first point image corresponding to a scene including the subject viewed from a first point and a second point image corresponding to a scene including the subject viewed from a second point different from the first point. The integrated circuit includes an obtaining unit, an estimation unit, and an adjustment unit.

The obtaining unit obtains subject size information indicating a size of the subject using information that is based on image data forming the first point image and the second point image or information that is based on settings used in forming the first point image and the second point image.

The estimation unit estimates a subject distance, which is a distance from the image pickup device to the subject, using the subject size information.

The adjustment unit adjusts an imaging parameter used by the imaging unit in a manner to change a disparity determined by the first point image and the second point image in accordance with at least information indicating the subject distance estimated by the estimation unit.

The integrated circuit has the same advantageous effects as the image pickup device of the first aspect of the present invention.

### Advantageous Effects

The stereo image pickup device, the stereo image obtaining method, the program, and the integrated circuit of the present invention enable an imaging parameter used in stereoscopic imaging (e.g., the stereo base (the distance between a right point for obtaining a right eye image and a left point for obtaining a left eye image) or the angle of convergence) to be set in an appropriate manner in accordance with information indicating the size of a subject, and thus enable a stereo image (a three-dimensional image) to be formed in a manner to reproduce a natural stereoscopic effect (a natural depth) when the image is viewed.

### BRIEF DESCRIPTION OF DRAWINGS

FIG. 1 is a schematic view of a stereo image pickup device 1000 according to a first embodiment.

FIGS. 2A and 2B are diagrams describing the relationship between the subject distance and the disparity.

FIGS. 3A and 3B are diagrams describing the relationship between the subject distance and the disparity.

FIGS. 4A and 4B are diagrams describing the optimum setting of the stereo base in accordance with the subject distance.

FIG. 5 is an example of a table showing the correspondence between the imaging mode and the estimated size of the subject.

FIG. 6 is a diagram describing a method for estimating the subject distance based on the subject size and the focal length.

FIGS. 7A and 7B are diagrams describing the subject distance, the stereo base, and the distance to the virtual screen.

FIGS. 8A and 8B are diagrams describing the subject distance, the stereo base, and the distance to the virtual screen.

FIG. 9 is a flowchart showing the processing performed by the stereo image pickup device 1000 according to the first embodiment.

FIG. 10 is a diagram describing a method for estimating the size of the subject based on face detection.

FIG. 11 is a diagram describing an example of the imaging mode in which the subject size can be estimated easily.

FIG. 12 schematically shows the structure of a stereo image pickup device 1000A according to a modification of the first embodiment.

FIG. 13 schematically shows the structure of a stereo image pickup device 2000 according to a second embodiment.

FIG. 14 schematically shows the structure of a stereo image pickup device 2000A according to a modification of the second embodiment.

FIG. 15 is a diagram describing the position of convergence.

FIG. 16 is a flowchart showing the processing performed by the stereo image pickup device 2000 according to the second embodiment.

FIG. 17 is a flowchart showing the operation for setting the stereo base in a conventional example.

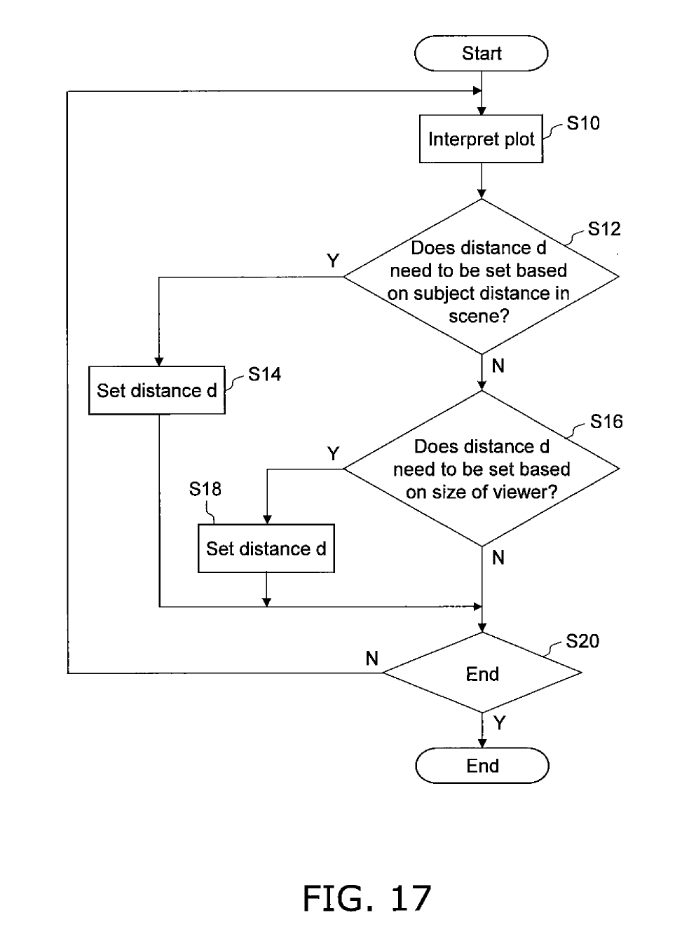

FIG. 18 is a flowchart showing in detail the processing performed in step S14 in FIG. 16 in the conventional example.

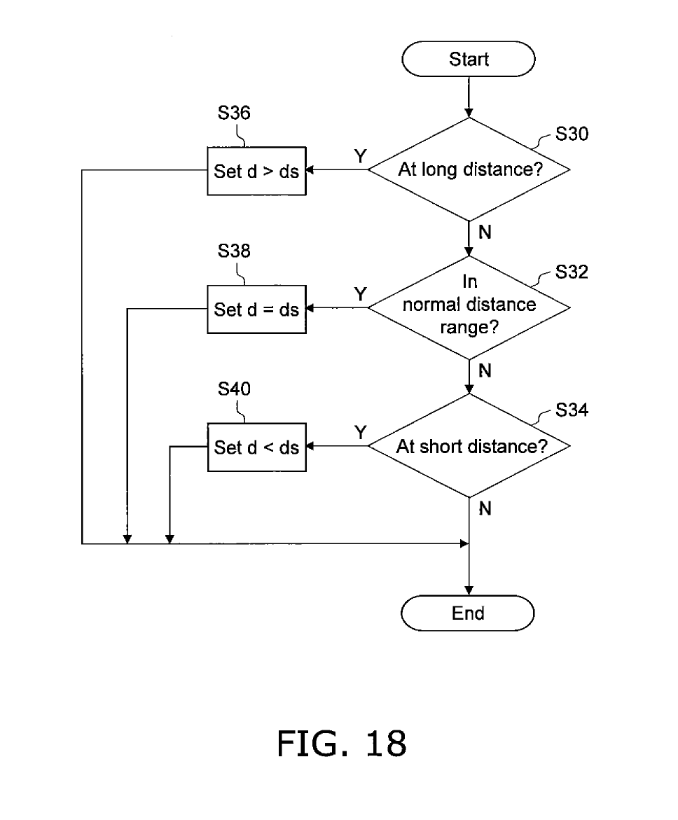

### DESCRIPTION OF EMBODIMENTS

Embodiments of the present invention will now be described with reference to the drawings.

### First Embodiment

### 1.1 Structure of the Stereo Image Pickup Device

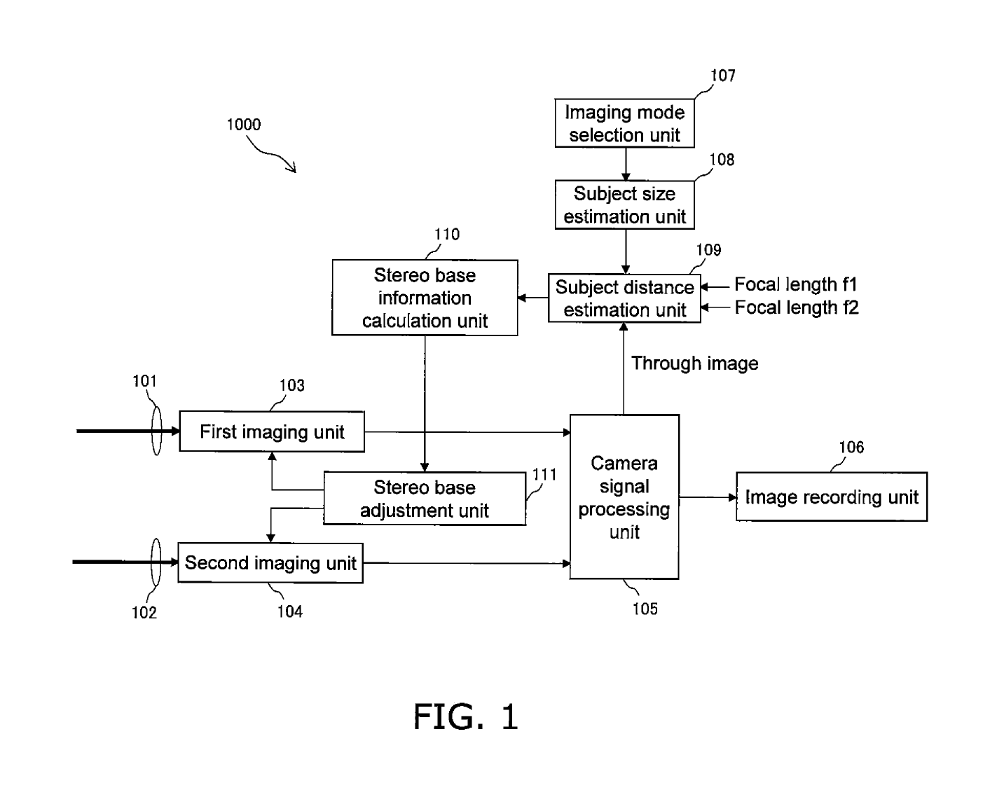

FIG. 1 schematically shows the structure of a stereo image pickup device 1000 according to a first embodiment.

As shown in FIG. 1, the stereo image pickup device 1000 includes an optical system 101, an optical system 102, a first imaging unit 103, a second imaging unit 104, a camera signal processing unit 105, an image recording unit 106, an imaging mode selection unit 107, a subject size estimation unit 108, a subject distance estimation unit 109, a stereo base information calculation unit 110, and a stereo base adjustment unit 111.

The stereo image pickup device 1000 includes a controller (not shown) for controlling all or some of its functional units. The controller is formed by, for example, a microprocessor, a read-only memory (ROM), or a random access memory (RAM).

All or some of the functional units of the stereo image pickup device 1000 may be connected to the controller either directly or via a bus.

The components of the stereo image pickup device 1000 will now be described in detail.

The optical system 101 includes an objective lens, a zoom lens, an aperture, and a focusing lens. The optical system 101 focuses light from a subject to form a subject image. The optical system 101 outputs the subject image to the first imaging unit 103. The optical system 101 receives a control signal corresponding to the imaging mode selected by the imaging mode selection unit 107, which is input from the controller controlling the entire operation of the stereo image pickup device 1000. In accordance with the control signal, the imaging parameters used in the optical system 101 (including the focal length, the exposure amount, the aperture stop, and the lens position) are adjusted.

The first imaging unit 103 forms a subject image using light focused by the optical system 101, and generates an image signal forming the subject image. The first imaging unit 103 outputs the generated image signal to the camera signal processing unit 105 as a first point image. The first imaging unit 103 includes a mechanism for aligning itself in accordance with a first adjustment signal input from the stereo base adjustment unit 111. The first imaging unit 103 is formed by an image sensor, such as a complementary metal oxide semiconductor (CMOS) image sensor or a charge coupled device (CCD) image sensor.

Each of the optical system 101 and the first imaging unit 103 may include a mechanism for aligning the optical system 101 and the first imaging unit 103 in an interlocked manner in accordance with the first adjustment signal. Alternatively, the optical system 101 and the first imaging unit 103 may be packed in a single unit, which may be aligned in accordance with the first adjustment signal.

The optical system 102 has the same structure as the optical system 101, and includes an objective lens, a zoom lens, an aperture, and a focusing lens. The optical system 102 focuses light from a subject to form a subject image. To enable the image pickup device to form a stereo image, the optical system 102 is arranged at a point of view different from that for the optical system 101. The optical system 102 receives a control signal corresponding to the imaging mode selected by the imaging mode selection unit 107, which is input from the controller controlling the entire operation of the stereo image pickup device 1000. In accordance with the control signal, the imaging parameters used in the optical system 102 (including the focal length, the exposure amount, the aperture stop, and the lens position) are adjusted.

The second imaging unit 104 forms a subject image using light focused by the optical system 102, and generates an image signal forming the subject image. The second imaging unit 104 outputs the generated image signal to the camera signal processing unit 105 as a second point image. The second imaging unit 104 includes a mechanism for aligning itself in accordance with a second adjustment signal input from the stereo base adjustment unit 111.

Each of the optical system 102 and the second imaging unit 104 may include a mechanism for aligning the optical system 102 and the second imaging unit 104 in an interlocked manner in accordance with the second adjustment signal. Alternatively, the optical system 102 and the second imaging unit 104 may be packed in a single unit, which may be aligned in accordance with the second adjustment signal. The first imaging unit 103 and the second imaging unit 104 may be formed using a single image sensor. When, for example, a single CMOS image sensor is used to form both the first and second imaging units, a first area of the entire CMOS area (the entire imaging surface of the CMOS image sensor) is used to receive light focused by the optical system 101, whereas a second area of the entire CMOS area different from the first area is used to receive light focused by the optical system 102. The optical system 101 and the optical system 102 are adjusted in accordance with the first adjustment signal and the second adjustment signal. In the same manner as described for the first imaging unit 103, the second imaging unit 104 is also formed by an image sensor such as a CMOS or a CCD.

The camera signal processing unit 105 receives the first point image output from the first imaging unit 103 and the second point image output from the second imaging unit 104, and processes the first point image and the second point image through camera signal processing (e.g., gain adjustment, gamma correction, aperture adjustment, white balance (WB) setting, and filter processing).

The camera signal processing unit 105 outputs the first point image and/or the second point image processed through the camera signal processing to the subject distance estimation unit 109.

The camera signal processing unit 105 also outputs the first point image and the second point image processed through the camera signal processing to the image recording unit 106. The camera signal processing unit 105 may convert the first point image and the second point image processed through the camera signal processing into a predetermined recording format, such as JPEG format, before outputting the first point image and the second point image to the image recording unit 106.

The image recording unit 106 records the first point image and the second point image processed through the camera signal processing and output from the camera signal processing unit 105 into, for example, an internal memory or an external memory (a nonvolatile memory for example) connected to the device. The image recording unit 106 may record the first point image and the second point image into a recording medium external to the stereo image pickup device 1000.

The imaging mode selection unit 107 obtains information indicating the imaging mode selected by the user, and outputs the obtained imaging mode information to the subject size estimation unit 108.

The imaging mode is set for an imaging scene assumed by the user. The stereo image pickup device 1000 may have, for example, (1) a portrait mode, (2) a child mode, (3) a pet mode, (4) a macro mode, and (5) a landscape mode. In accordance with the imaging mode selected from these different modes, the stereo image pickup device 1000 sets the imaging parameter in an appropriate manner. The stereo image pickup device 1000 may also have an auto mode for automatic imaging. In the auto mode, the stereo image pickup device 1000 automatically selects an appropriate imaging mode from the different imaging modes.

The subject size estimation unit 108 receives information indicating the imaging mode output from the imaging mode selection unit 107, and determines (estimates) the subject size based on the selected imaging mode. The subject size is information indicating the actual size of the subject, such as the height of the subject or the width of the subject.

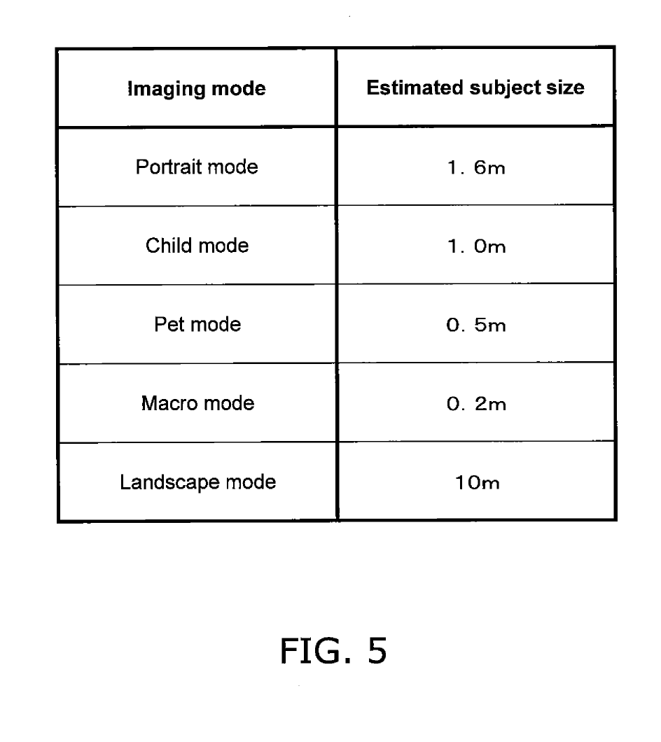

The subject size estimation unit 108 includes an estimation table showing the correspondence between the imaging mode and the estimated subject size. FIG. 5 shows an example of the estimation table showing the correspondence between the imaging mode and the estimated subject size. The subject size estimation unit 108 determines (estimates) the subject size based on the selected imaging mode using the estimation table.

The subject size estimation unit 108 then outputs subject information including at least the determined (estimated) subject size to the subject distance estimation unit 109. The subject information may also include information indicating the selected imaging mode. The subject size estimation unit 108 may not include the estimation table, but may only store functions defining the correspondence between the imaging mode and the estimated subject size.

The subject distance estimation unit 109 receives the subject information output from the subject size estimation unit 108, information indicating the focal length f1 of the optical system 101 and/or information indicating the focal length f2 of the optical system 102 obtained by the controller, and the first point image and/or the second point image processed through the camera signal processing and output from the camera signal processing unit 105 (hereafter referred to as a through image signal), and calculates the subject distance L, which is the distance from the stereo image pickup device 1000 to the subject.

More specifically, the subject distance estimation unit 109 obtains the height of the subject imaged by the image sensor forming the first imaging unit 103 and/or of the subject imaged by the image sensor forming the second imaging unit 104 based on the through image signal, and geometrically calculates the subject distance L using the obtained height, the focal length f1 and/or the focal length f2, and the subject size indicated by the subject information. The stereo image pickup device 1000 prestores the size S of the image sensor. The through image signal is only required to form one of the first point image and the second point image. The subject distance estimation unit 109 estimates the subject distance using the focal length f1 when the through image signal forms the first point image. The subject distance estimation unit 109 estimates the subject distance using the focal length f2 when the through image signal forms the second point image. When the through image signal forms a fixed one of the first point image and the second point image, the subject distance estimation unit 109 is only required to obtain information indicating the focal length corresponding to the point image to be formed by the fixed one of the image signals.

The subject distance estimation unit 109 outputs subject distance information indicating the estimated subject distance L to the stereo base information calculation unit 110.

The stereo base information calculation unit 110 receives the viewing distance set in advance and the subject distance information output from the subject distance estimation unit 109, and calculates the stereo base (the distance between a right point for obtaining a right eye image and a left point for obtaining a left eye image) in a manner that the disparity of the subject during viewing is a target disparity. The stereo base calculation unit 110 outputs stereo base information, which is information indicating the calculated stereo base (the distance between a right point for obtaining a right eye image and a left point for obtaining a left eye image), to the stereo base adjustment unit 111.

The viewing distance refers to the distance between the viewer and the display device that displays the first point image and the second point image when the first point image and the second point image recorded in the image recording unit 106 are viewed. The viewing distance may be set by the user when the user uses the stereo image pickup device 1000 to take photos, or it may be set based on a reference value determined by the manufacturer at the shipment of the stereo image pickup device 1000. Alternatively, the viewing distance may be set by the user in accordance with his/her home environment, or may be set to a standard viewing distance (such as the distance three times the height of the screen) calculated inside a camera based on the number of inches of the screen of the user's television set registered by the user. Alternatively, the viewing distance may be set based on a standard viewing distance calculated by the number of inches of a standard television set assumed by the manufacturer at the shipment of the stereo image pickup device.

When, for example, the designer of the stereo image pickup device 1000 values safety, the target disparity is a disparity that enables the viewer to perceive an image formed using the image signal as a three-dimensional image, or a disparity that enables the physical safety of the viewer to be secured when the image formed using the image signal is viewed.

The stereo base adjustment unit 111 calculates a first adjustment signal for aligning the first imaging unit 103 and/or the optical system 101 and a second adjustment signal for aligning the second imaging unit 104 and/or the optical system 102 based on the stereo base information output from the stereo base information calculation unit 110. More specifically, the stereo base adjustment unit 111 calculates the first adjustment signal and the second adjustment signal that cause the relative positions of the first imaging unit 103 and the second imaging unit 104 (the relative positions of the optical system 101 and the first imaging unit 103 and the relative positions of the optical system 102 and the second imaging unit 104) to correspond to the stereo base calculated by the stereo base information calculation unit 110.

The stereo base adjustment unit 111 may adjust the relative positions of the first imaging unit 103 and the second imaging unit 104 through the processing (1) and (2) below:

(1) In accordance with the first adjustment signal output from the stereo base adjustment unit 111, the optical system 101 and the first imaging unit 103 moves in an interlocked manner. In accordance with the second adjustment signal, the optical system 102 and the second imaging unit 104 also move in an interlocked manner. This adjusts the relative positions of the first imaging unit 103 and the second imaging unit 104.

(2) The unit consisting of the optical system 101 and the first imaging unit 103 moves in accordance with the first adjustment signal. The unit consisting of the optical system 102 and the second imaging unit 104 moves in accordance with the second adjustment signal. This adjusts the relative positions of the first imaging unit 103 and the second imaging unit 104.

The first image signal (the image signal forming the first point image) and the second image signal (the image signal forming the second point image) are only required to satisfy the stereo base indicated by the stereo base information. The physical distance between the first imaging unit 103 and the second imaging unit 104 may not necessarily be the same as the stereo base. For example, the optical system 101 and the optical system 102 may further include a mechanism for changing the optical path on which light from the subject is focused. The optical path may then be changed in a manner to form the first point image and the second point image satisfying the stereo base.

### 1.2 Operation of the Stereo Image Pickup Device

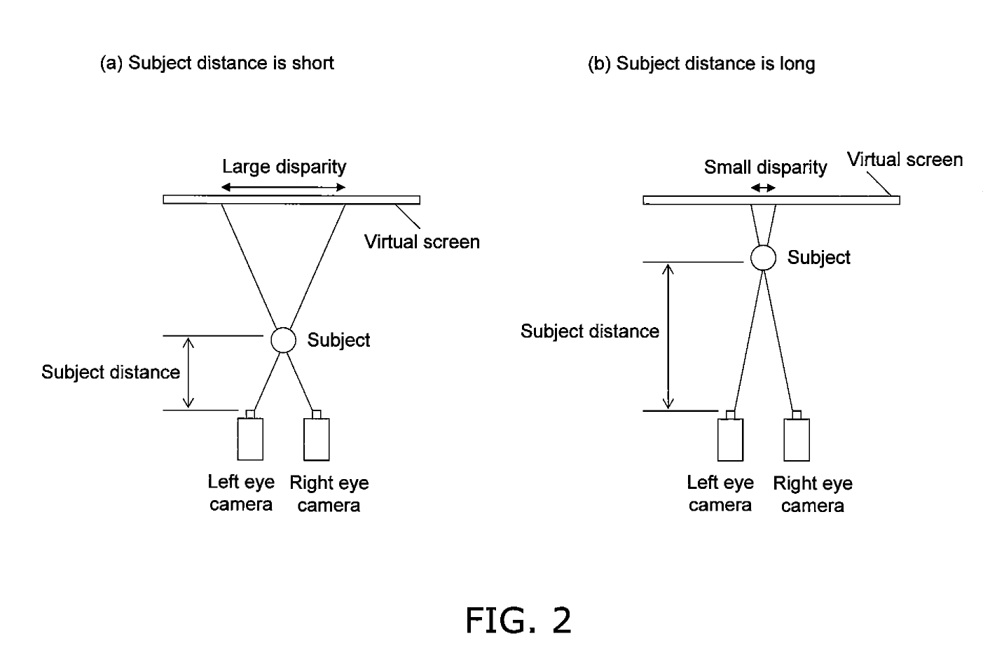

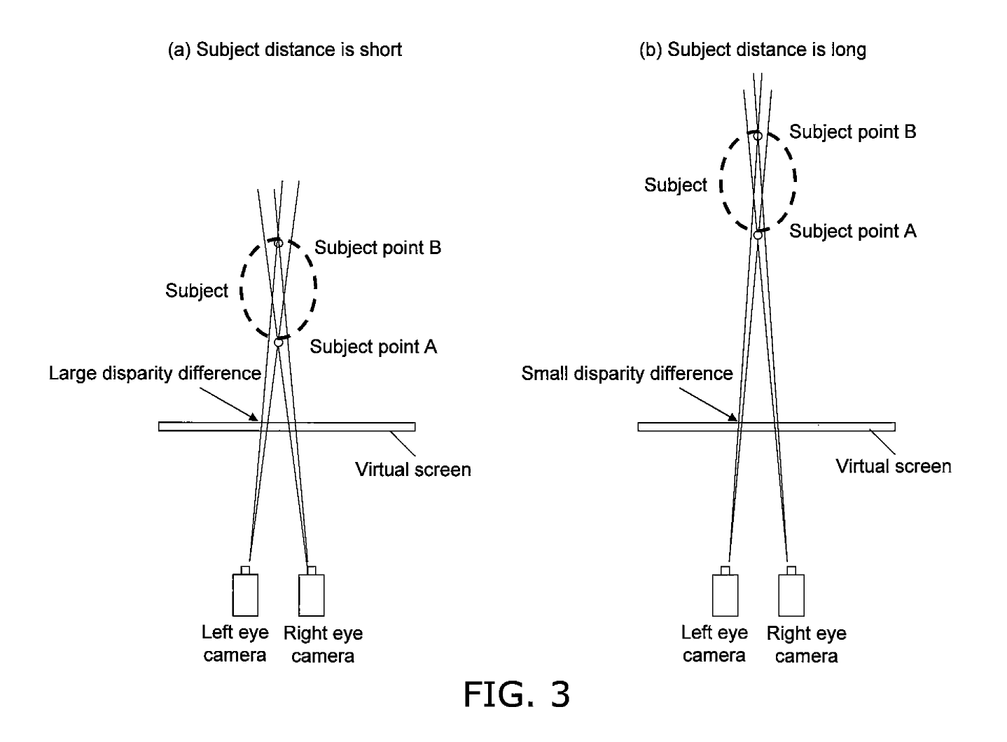

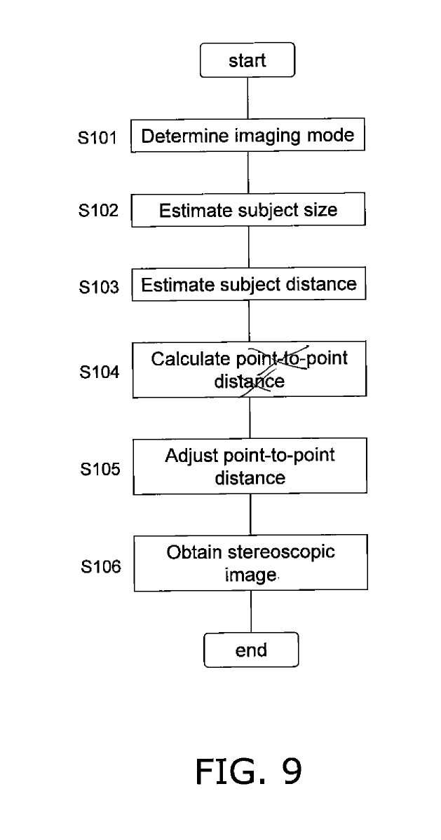

The operation of the stereo image pickup device 1000 with the above-described structure will now be described with reference to FIGS. 1 to 11. FIG. 9 is a flowchart showing the processing corresponding to a stereo image obtaining method implemented by the stereo image pickup device 1000.

For ease of convenience, the subject size estimation unit 108 determines (estimates) the height h of the subject. The subject size estimation unit 108 stores the estimation table shown in FIG. 5.

### Step S101:

The imaging mode selection unit 107 first obtains the imaging mode currently set in the stereo image pickup device 1000. The imaging mode selection unit 107 outputs information indicating the obtained imaging mode to the subject size estimation unit 108.

### Step S102:

The subject size estimation unit 108 determines (estimates) the height h of the subject in accordance with the imaging mode information output from the imaging mode selection unit 107, and outputs subject information including at least information indicating the determined (estimated) subject height h to the subject distance estimation unit 109. More specifically, the subject size estimation unit 108 obtains the height h of the subject from the estimation table in accordance with the imaging mode indicated by the imaging mode information. When, for example, the imaging mode selected by the imaging mode selection unit 107 is the portrait mode, the subject size estimation unit 108 refers to the estimation table, and obtains the height of 1.6 m as the estimated subject size corresponding to the portrait mode. The subject size estimation unit 108 then outputs subject information including the subject size information indicating 1.6 m and the imaging mode information indicating the portrait mode to the subject distance estimation unit 109.

### Step S103:

The subject distance estimation unit 109 calculates the subject distance L using the subject information output from the subject size estimation unit 108, information indicating the focal length f1 of the optical system 101 and/or the focal length f2 of the optical system 102, and the through image signal input from the camera signal processing unit 105.

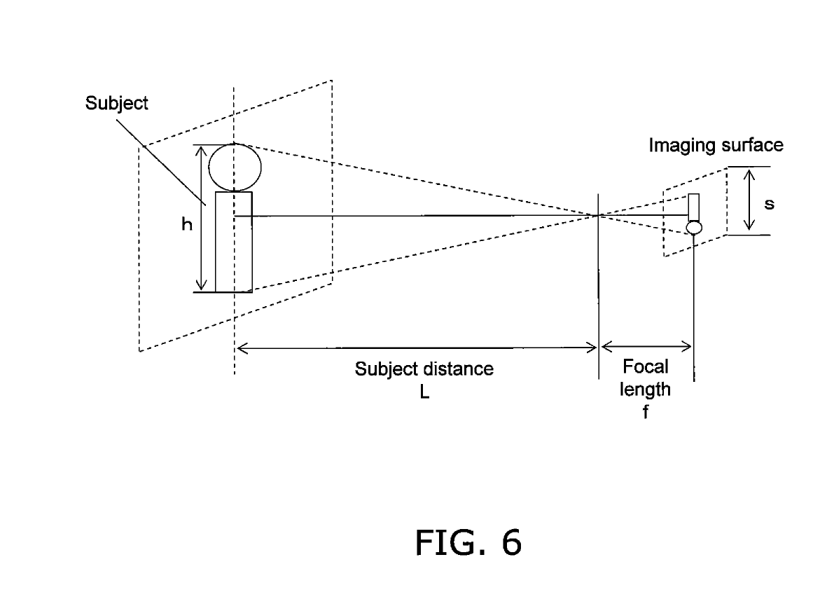

FIG. 6 is a diagram describing a method for estimating the subject distance based on the subject size and the focal length. The method for calculating the subject distance L used by the subject distance estimation unit 109 will now be described in detail.

The subject distance estimation unit 109 obtains the height of a target subject obtained by the image sensor forming the first imaging unit 103 and/or the height of the target subject obtained by the second imaging unit 104 based on the through image signal. More specifically, the subject distance estimation unit 109 calculates the height of the target subject obtained by the image sensor as ¾s, where s is the size (height) of the image sensor, and the height of the subject corresponds to 810 pixels out of 1080 vertical pixels in the through image.

The subject distance estimation unit 109 further calculates the subject distance L using equation 1 below, in which f is the focal length, h is the height of the subject, and s is the height of the target subject on the imaging surface. In other words, the subject distance estimation unit 109 geometrically calculates the subject distance L using the height S of the target subject on the imaging surface, the focal length f, and the subject height h.

L=4/3*(h*f/s) Equation 1

The subject distance estimation unit 109 outputs the subject distance information including the calculated subject distance L to the stereo base information calculation unit 110.

### Step S104:

The stereo base information calculation unit 110 calculates the stereo base information to be set for the first imaging unit 103 and the second imaging unit 104 based on a predetermined condition and the subject distance L, which is estimated by the subject distance estimation unit 109. For example, the stereo base information calculation unit 110 calculates the stereo base information in a manner that the disparity on the virtual screen will be less than or equal to a first threshold. The stereo base information calculation unit 110 also calculates the stereo base information in a manner that the disparity on the virtual screen will be greater than or equal to a second threshold. The stereo base information calculation unit 110 then outputs the calculated stereo base information to the stereo base adjustment unit 111. The virtual screen refers to a virtually set display screen on which the first point image and the second point image are assumed to be displayed.

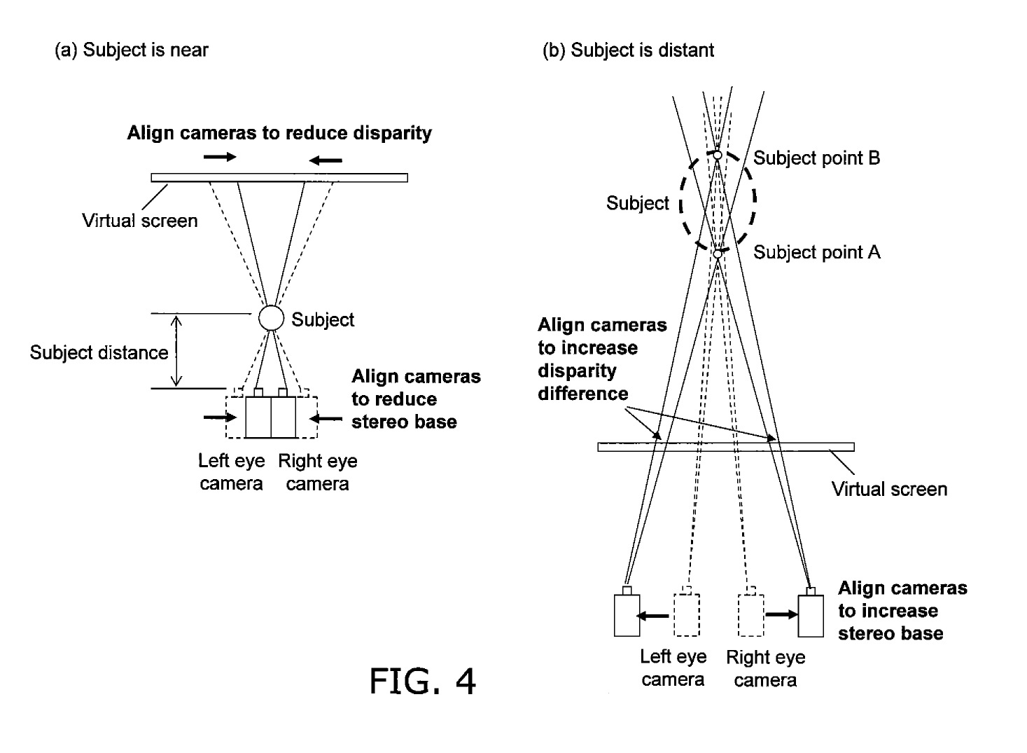

The optical system 101 corresponds to (the optical system of) a right eye camera shown in FIGS. 4A and 4B, whereas the optical system 102 corresponds to (the optical system of) a left eye camera shown in FIGS. 4A and 4B. An image obtained by the right eye camera shown in FIGS. 4A and 4B corresponds to an image formed using the first image signal, whereas an image obtained by the left eye camera shown in FIGS. 4A and 4B corresponds to an image formed using the second image signal.

The operation for generating the stereo base information based on the subject distance L will be described in detail later.

### Step S105:

The stereo base adjustment unit 111 generates the first adjustment signal and the second adjustment signal based on the stereo base information output from the stereo base information calculation unit 110, and outputs the first adjustment signal to the first imaging unit 103 and the second adjustment signal to the second imaging unit 104. The first imaging unit 103 adjusts the relative position of the first imaging unit in accordance with the first adjustment signal. The second imaging unit 104 adjusts the relative position of the second imaging unit in accordance with the second adjustment signal.

### Step S106:

After the adjustment, each of the first imaging unit 103 and the second imaging unit 104 images the subject to generate an image (a stereo image) corresponding to the stereo base calculated by the stereo base information calculation unit 110.

The image signals obtained by the first imaging unit 103 and the second imaging unit 104 are then processed through the camera processing performed by the camera signal processing unit 105, and then recorded as stereo image data by the image recording unit 106.

### 1.3 Detailed Operation of the Stereo base Information Calculation Unit 110

The operation performed by the stereo base information calculation unit 110 for calculating the stereo base will now be described with reference to the drawings.

### 1.3.1 When Scene Includes Single Subject Requiring Disparity Adjustment

The operation of the stereo base information calculation unit 110 performed when the imaging scene includes only a single subject requiring disparity adjustment will now be described.

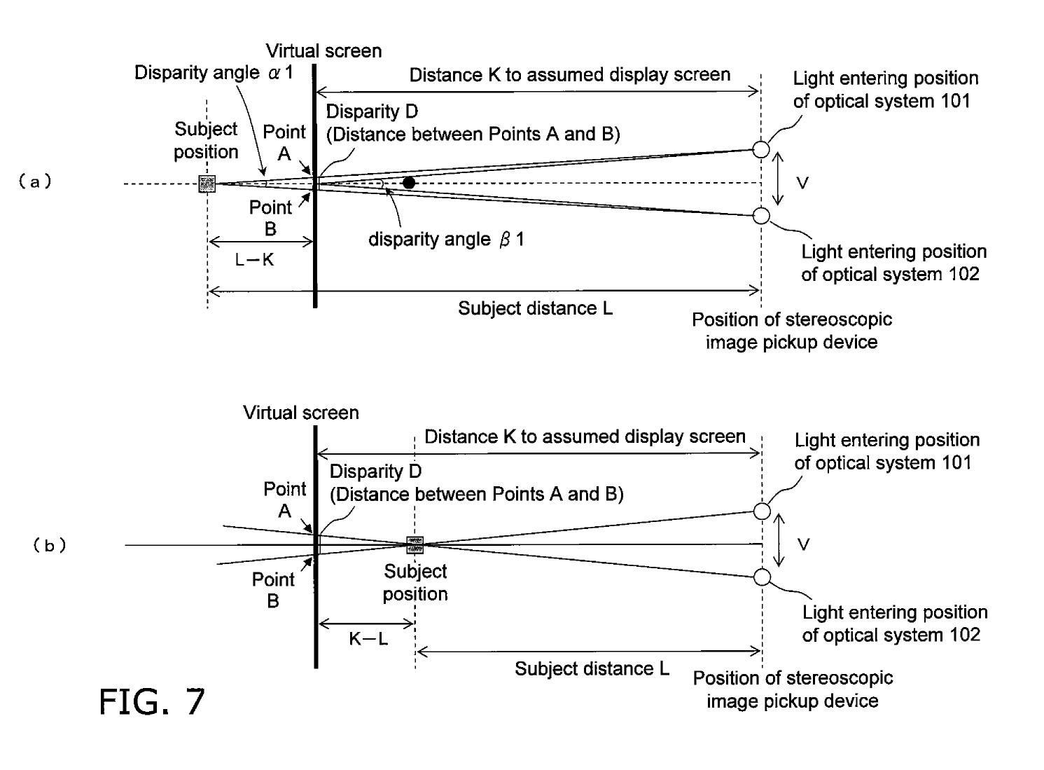

FIGS. 7A and 7B are diagrams describing the relationship between the distance L to the target subject, the viewing distance K, the stereo base V (the distance between the light entering position of the optical system 101 and the light entering position of the optical system 102), and the target disparity D on the virtual screen. The target disparity D is a variable determined based on a predetermined condition. The light entering position is a position at which light from the subject enters the optical system 101 or 102, and specifically corresponds to the principle point of the lens of the optical system 101 or 102 when the optical system is assumed to consist of the single lens. In the present embodiment, the light entering point should not be limited to the position corresponding to the principle point of the lens, but may be any position in the stereo image pickup device 1000, such as the gravity center of the entire lens or the sensor surface position of the first or second imaging unit 103 or 104. In FIGS. 7A and 7B, the viewing distance K is the distance between the camera position and the virtual screen.

As shown in FIG. 7A, the stereo base information calculation unit 110 calculates the stereo base V using equation 2 below based on the geometric characteristics when the subject is behind the virtual screen.

V=D*L/(L−K) Equation 2

As shown in FIG. 7B, the stereo base calculation unit 110 further calculates the stereo base V using equation 3 below based on the geometric characteristics when the subject is in front of the virtual screen.

V=−D*L/(L−K) Equation 3

The target disparity may be set at any value but preferably set at a value with which the stereo image pickup device 1000 would form a stereo image that reproduces a natural stereoscopic effect. The stereo image that reproduces a natural stereoscopic effect is, for example, (1) a stereo image with an appropriate disparity that can be fused in an appropriate manner (without being perceived as a double image) when the stereo image is viewed by the viewer, or (2) a stereo image with an appropriate disparity that reproduces an appropriate stereoscopic effect of a predetermined object in the image (reproduces an appropriate stereoscopic effect of the real object (e.g., reproduces unevenness in the object surface) without causing for example a phenomenon in which a predetermined object is flattened in depth (“cardboard” effect)) when the stereo image is viewed by the viewer.

When the designer of the stereo image pickup device 1000 values the stereoscopic effect produced at viewing, the target disparity may be set to fall within a stereoscopic-viewing enabling area, which is set as a typical area within which a stereo image will avoid being perceived as a double image when the stereo image is viewed. The target disparity falling within such an area may for example be set in a manner that the absolute value of a difference between an angle α1, as shown in FIG. 7A, formed by the stereo image pickup device 1000 and the subject and an angle β1, as shown in FIG. 7A, formed by the stereo image pickup device 1000 and the virtual screen would be less than or equal to 1 degree. A disparity falling within the stereoscopic-viewing enabling area may not be limited to the above specified disparity value, but may vary depending on the performance of the display device or on the viewing environment. The target disparity may also be set in accordance with any other reference value.

The stereo base information calculation unit 110 then outputs the stereo base information indicating the calculated stereo base V to the stereo base adjustment unit 111.

### 1.3.2 When Scene Includes Plurality of Subjects Requiring Disparity Adjustment

The operation of the stereo base information calculation unit 110 performed when the imaging scene includes a plurality of subjects requiring disparity adjustment will now be described.

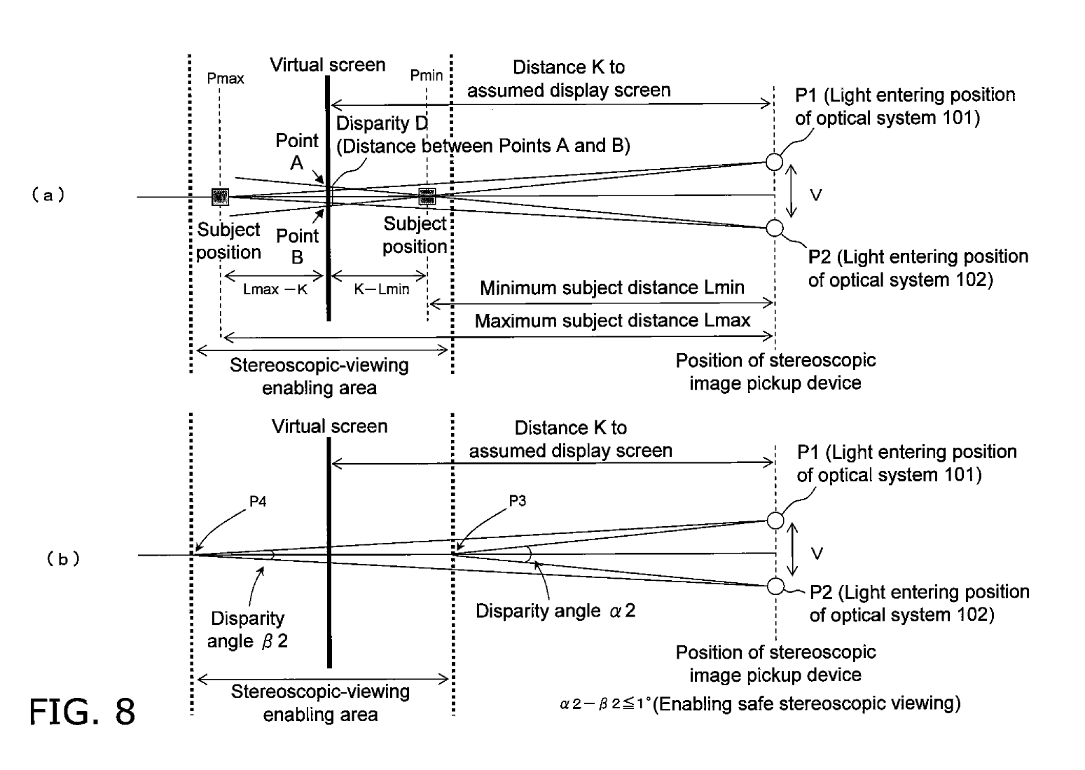

FIGS. 8A and 8B are diagrams each describing the same relationship as in FIGS. 7A and 7B for a scene including two subjects. Parts in FIGS. 8A and 8B that are the same as in FIGS. 7A and 7B are labeled the same, and will not be described.

The stereo base information calculation unit 110 sets the stereo base V in a manner that the disparity for each of the two subjects will be its target disparity. The target disparity for each subject may be set at any value based on a predetermined reference.

The disparity adjustment performed when the designer of the stereo image pickup device 1000 values safety will now be described. The position of the subject that is nearest from the image pickup device 1000 is Pmin, and the position of the subject that is most distant from the image pickup device 1000 is Pmax.

In this case, it is preferable to adjust the stereo base V used for obtaining a stereo image in a manner that a disparity difference within an area from the position Pmin to the position Pmax will be a disparity difference with which the resulting stereo image can be fused in an appropriate manner by common viewers. More specifically, it is preferable to adjust the stereo base V in a manner that the area from the position Pmin to the position Pmax, as shown in FIG. 8A, will fall within a stereoscopic-viewing enabling area. The stereoscopic-viewing enabling area will now be described with reference to FIG. 8B.

In FIG. 8B, P1 is the position at which light enters the optical system 101, and P2 is the position at which light enters the optical system 102. Positions P3 and P4 are set as shown in FIG. 8B. In this case, when an angle α2 formed by the line P1-P3 and the line P3-P2 and an angle β2 formed by the line P1-P4 and the line P4-P2 satisfy the relationship defined by equation 4 below, the area between the positions P3 and P4 shown in FIG. 8B falls within the stereoscopic-viewing enabling area. When the subject positions are within this area, the resulting stereo image will be an image that can be fused by many viewers.

|α2−β2|≦1° Equation 4

In the stereo image pickup device 1000, the stereo base information calculation unit 110 calculates the stereo base V in a manner that the area between the positions Pmin to Pmax will fall within the stereoscopic-viewing enabling area.

The stereo base information calculation unit 110 outputs the stereo base information indicating the calculated stereo base V to the stereo base adjustment unit 111.

As described above, the stereo image pickup device 1000 determines (estimates) the size of a subject in accordance with the imaging mode, and calculates the subject distance L, which is the distance to the subject, using the determined (estimated) subject size and the focal length. The stereo image pickup device 1000 further calculates the stereo base (the distance between a right point for obtaining a right eye image and a left point for obtaining a left eye image) corresponding to an optimum disparity (e.g., a disparity falling within the stereoscopic-viewing enabling area) using the distance to the subject, and then determines the stereo base (the distance between a right point for obtaining a right eye image and a left point for obtaining a left eye image) based on the calculated value. The stereo image pickup device 1000 then aligns the two imaging units (the first imaging unit 103 and the second imaging unit 104) in a manner to correspond to the determined stereo base (in a manner to enable a stereo image to be formed at the determined stereo base), and then obtains a stereo image using the two imaging units (the first imaging unit 103 and the second imaging unit 104). When this stereo image is displayed on the display device, the image will have an appropriate disparity on the virtual screen (on the display screen of the display device). As a result, the displayed stereo image will have an appropriate stereoscopic effect. In this manner, the above processing enables the stereo image pickup device 1000 to form a stereo image having an appropriate stereoscopic effect.

Although the above embodiment describes the case in which the stereo image pickup device 1000 determines an optimum disparity based on a disparity that falls within the stereoscopic-viewing enabling area, the present invention should not be limited to this structure. For example, the stereo image pickup device 1000 may determine an optimum disparity based on a reference value for enabling a predetermined object to have an appropriate stereoscopic effect (e.g., reproduce appropriate unevenness in the object surface by preventing the cardboard effect).

The stereo image pickup device 1000 may not include the stereo base adjustment unit 111. In this case, the stereo image pickup device 1000 may provide the user with stereo base information indicating the stereo base to be set in the device. The user may then set the stereo base.

The stereo base information calculation unit 110 may fail to physically set the stereo base when the stereo base indicated by the stereo base information exceeds a predetermined range. In this case, the stereo image pickup device 1000 may provide the user with warning information by displaying such information on a monitor screen or by using a lamp.

The stereo image pickup device 1000 may have a twin-lens imaging mode in which both the first imaging unit 103 and the second imaging unit 104 are used to form a stereo image and a double-shooting imaging mode in which only one of the first imaging unit 103 and the second imaging unit 104 is used and imaging is performed twice or more to form a stereo image. The stereo base information calculation unit 110 may select the twin-lens imaging mode as the operating mode of the stereo image pickup device 1000 when the stereo base falls within a predetermined area (for example the stereoscopic-viewing enabling area). The stereo base information calculation unit 110 may then select the double-shooting imaging mode as the operating mode when the stereo base indicated by the stereo base information is beyond a predetermined area (for example the stereoscopic-viewing enabling area). In this case, the stereo image pickup device 1000 may perform the processing described below. When the twin-lens imaging mode is selected, the stereo base adjustment unit 111 adjusts the relative positions of the first imaging unit 103 and the second imaging unit 104 and forms an image using both the first and second imaging units 103 and 104. When the double-shooting imaging mode is selected, the stereo image pickup device 1000 urges the user to perform imaging twice at predetermined different distances using one of the first imaging unit 103 and the second imaging unit 104.

The subject distance estimation unit 109 may also perform face detection (detecting an image area forming a face in an image). In this case, the subject distance estimation unit 109 calculates the size or the position of the face area detected through this processing, and estimates the size of the subject based on the calculated size or the calculated position of the face area.

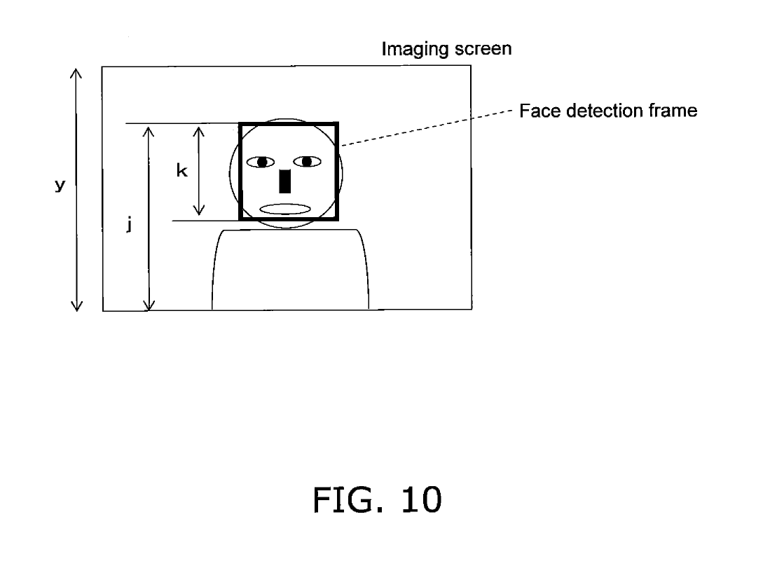

FIG. 10 is a diagram describing a method for estimating the subject size based on the face detection. When the size (height) of the face is assumed to be 0.25 m, the subject distance L can be estimated using equation 5 below based on the same principle as shown in FIG. 6. In the equation, k is the height of a frame in which a face is detected, and y is the height of an image being formed (an image formed using a through image signal).

L=y/k*(h*f/s) Equation 5

The subject distance estimation unit 109 may calculate the subject distance using the size j in the detected frame in the figure instead of using the height k of the detected frame.

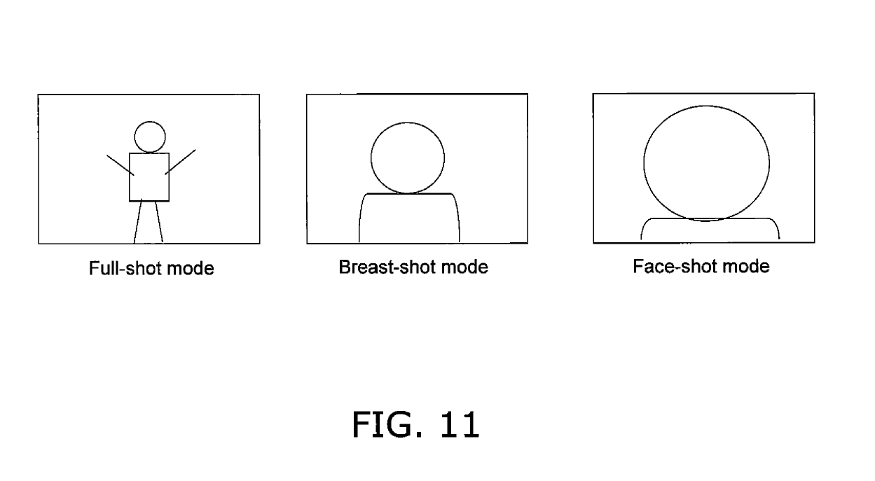

The stereo image pickup device 1000 may additionally have imaging modes in which the subject size can be estimated easily by using parts of the subject. With such imaging modes being added, the stereo image pickup device 1000 can estimate the subject size more precisely. FIG. 11 is a diagram describing examples of such imaging modes in which the subject size can be estimated easily. As shown in FIG. 11, the portrait mode may be divided into modes for smaller parts: (1) a full-shot mode for shooting the entire body of a person, (2) a breast-shot mode for shooting the upper half body, and (3) a face-shot mode for shooting a face of a person. The addition of these modes enables the stereo image pickup device 1000 to estimate the size of the person more precisely. The stereo image pickup device 1000 may have any imaging modes for imaging parts of a subject, which may not necessarily be the above modes for smaller parts of the portrait mode.

The processing from steps S101 to S105 may be performed only at the initial setting of the stereo image pickup device 1000 performed when the user intends to image a subject. In this case, the stereo base, which is automatically set in accordance with the user's intended purpose, can be freely changed after the initial setting.

The processing in step S103 and subsequent steps may be performed only when the shutter button of the stereo image pickup device 1000 is pressed halfway.

In the same imaging mode of the stereo image pickup device 1000, the processing in step S103 and subsequent steps may be performed only when information indicating the focal length f1 of the optical system 101 and/or information indicating the focal length f2 of the optical system 102 is changed.

### Outline of First Embodiment

As described above, the stereo image pickup device of the present embodiment determines (estimates) the subject size information indicating the size of the subject in accordance with the imaging mode for example, and estimates the distance to the subject using the focal length of the stereo image pickup device and using the subject size information. The stereo image pickup device of the present embodiment further adjusts an imaging parameter of the stereo image pickup device (e.g., the stereo base) in a manner to form a stereo image that reproduces an appropriate stereoscopic effect based on the estimated subject distance.

As a result, the stereo image pickup device of the present embodiment forms a stereo image that reproduces an appropriate stereoscopic effect.

The stereo image pickup device of the present embodiment, which estimates the subject distance in accordance with the imaging mode and sets the appropriate imaging parameter, enables stereoscopic imaging to be performed easily and also as intended by the user without requiring the user to have special knowledge about stereoscopic viewing.

The first imaging unit 103 and the second imaging unit 104 each are an example of an imaging unit.

The subject size estimation unit is an example of an obtaining unit.

The subject distance estimation unit 109 is an example of an estimation unit.

The stereo base calculation unit 110 and the stereo base adjustment unit 111 each are an example of an adjustment unit.

The imaging mode selection unit 107 is an example of a setting unit.

The subject size estimation unit 108 can store information showing the correspondence between the imaging mode and the estimated subject size as shown in FIG. 5. The subject size estimation unit 108 can thus function as a storage unit.

The subject distance estimation unit 109 detects an image area corresponding to the subject being imaged using a through image output from the camera signal processing unit 105. The subject distance estimation unit 109 can thus function as a detection unit.

### Modifications

Modifications of the present embodiment will now be described.

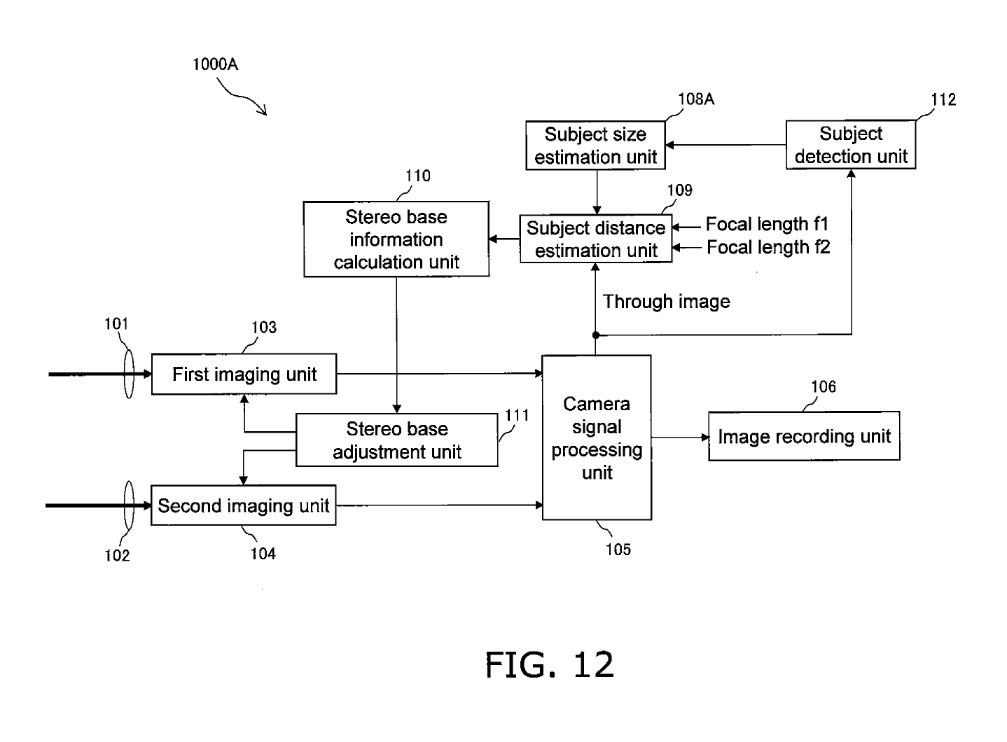

FIG. 12 schematically shows the structure of a stereo image pickup device 1000A according to a modification of the present embodiment.

As shown in FIG. 12, the stereo image pickup device 1000A according to the modification has the same structure as the stereo image pickup device 1000 of the first embodiment except that it (1) eliminates the imaging mode selection unit 107, (2) additionally includes a subject detection unit 112, and (3) includes a subject size estimation unit 108A instead of the subject size estimation unit 108.

The stereo image pickup device 1000A according to the modification will now be described focusing on its differences from the stereo image pickup device 1000 of the first embodiment.

The subject detection unit 112 receives an output (a through image) from the camera signal processing unit 105, and analyzes the input through image to detect an image area corresponding to a predetermined subject (e.g., a face of a person or a full portrait) from the through image. When, for example, intending to detect a person's face, the subject detection unit 112 detects an image area forming a person's face from the through image. The subject detection unit 112 then outputs information about the type of the detected subject (e.g., a person's face or a full portrait), the ratio of the size of the detected image area to the height of the through image on the screen, or both the height of the through image on the screen (information indicated by y in FIG. 10 for example) and the height of the detected image area (information indicated by k in FIG. 10) to the subject size estimation unit 108A.

For ease of explanation, a subject area to be detected by the subject detection unit 112 is assumed to be a person's face as shown in FIG. 10, and y is the height of the through image on the screen, and k is the height of the face area.

The subject size estimation unit 108A receives information indicating that the subject area to be detected is a person's face, information indicating the height y of the through image on the screen, and information indicating the height k of the detected face area, which is input from the subject detection unit 112.

In the same manner as described with reference to FIG. 10, the subject size estimation unit 108A calculates the subject distance L (the distance to the subject corresponding to a person's face detected by the stereo image pickup device 1000A) using the equation below.

L=y/k*(h*f/s), where L is the subject distance (the distance to the subject corresponding to a person's face detected by the stereo image pickup device 1000A) and s is the size (height) of the image sensor.

In this example, the subject area to be detected is a person's face. Thus, the subject size estimation unit 108A uses, for example, 0.25 m as the value of h in the equation above.

When the subject area to be detected is other than a person's face, the subject size estimation unit 108A sets a different value as the value of h in accordance with the intended subject area. When, for example, the intended subject area is a full portrait of an adult, the value h in the above equation may be set to, for example, 1.6 m. When the intended subject area is a full portrait of a child, the value h in the above equation may be set to, for example, 1.0 m. To increase the estimation precision of the subject distance L, the stereo image pickup device 1000A may in advance register data about a specific person (e.g., image data representing the specific person or the physical characteristics of the specific person including the height, the skin color, etc.), and may use the registered data about the specific person when the specific person is detected. For example, the stereo image pickup device 1000A may in advance register data representing the height of a specific person A (1.74 m for example) and the characteristic data of the person A (the physical characteristic data). When detecting a full portrait of the person A in a through image based on the registered characteristic data of the person A, the subject detection unit 112 may detect the full portrait of the person A as a subject area to be detected. In the same manner as described above, the subject detection unit 112 then outputs information indicating that the intended subject area is the full portrait of the person A, information indicating the height k of the person A in the through image, and information indicating the height y of the through image to the subject size estimation unit 108A.

The subject size estimation unit 108A then calculates the subject distance L (the distance from the stereo image pickup device 1000A to the person A) using the equation below using the information obtained from the subject detection unit 112.

L=y/k*(h*f/s).

In this case, the registered height data of the person A (1.74 m for example), which has a higher precision, can be used as the value of h in the equation. This enables the stereo image pickup device 1000A to estimate the subject distance L with a higher precision.

The subsequent processing (the processing performed by the stereo base information calculation unit 110 and the stereo base adjustment unit 111) is the same as described in the first embodiment.

As described above, the stereo image pickup device 1000A according to this modification detects an image area forming a specific subject, and uses the registered data on the specific subject. This enables the stereo image pickup device 1000A to estimate the subject distance with a higher precision. The stereo image pickup device 1000A according to this modification sets the imaging parameter used in stereoscopic imaging (e.g., the stereo base (the distance between a right point for obtaining a right eye image and a left point for obtaining a left eye image)) in an appropriate manner using the subject distance estimated with a higher precision. As a result, the stereo image pickup device 1000A forms a stereo image (a three-dimensional image) that can reproduce a natural stereoscopic effect (a natural depth) when the image is viewed.

The subject detection unit 112 is an example of the detection unit.

The subject size estimation unit 108A is an example of the obtaining unit.

### Second Embodiment

A second embodiment of the present invention will now be described with reference to the drawings.

### 2.1 Structure of the Stereo Image Pickup Device

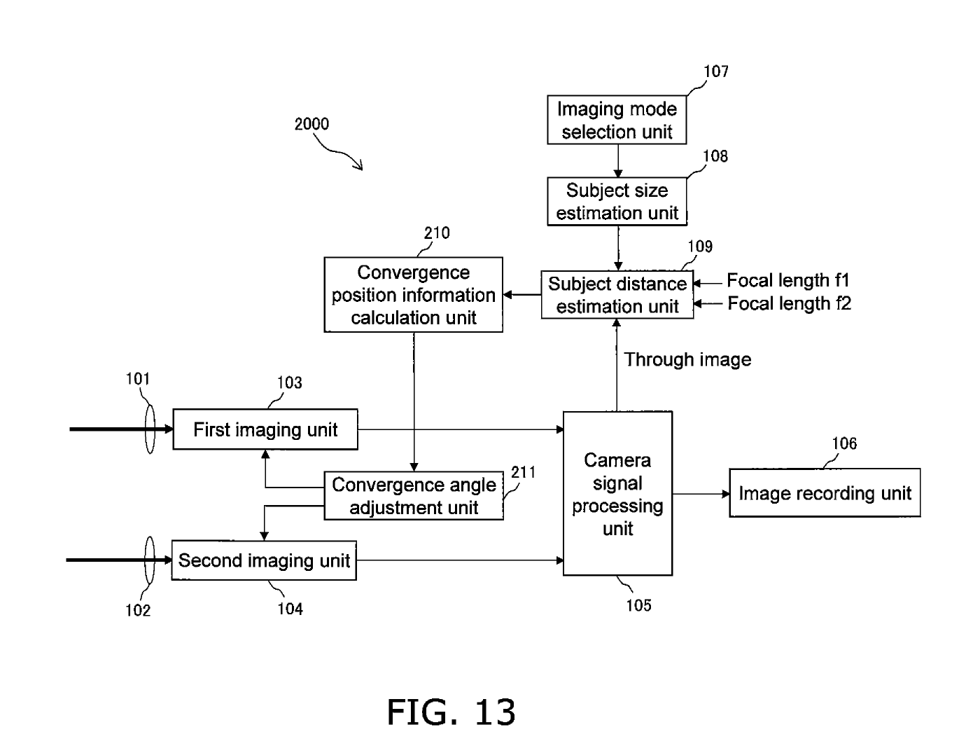

FIG. 13 schematically shows the structure of a stereo image pickup device 2000 according to the second embodiment. The stereo image pickup device 2000 of the present embodiment has the same structure as the stereo image pickup device 1000 of the first embodiment excepts that it includes a convergence position information calculation unit 210 and a convergence angle adjustment unit 211 instead of the stereo base calculation unit 110 and the stereo base adjustment unit 111 included in the stereo image pickup device 1000 of the first embodiment. The components of the stereo image pickup device 2000 of the second embodiment that are the same as the components of the stereo image pickup device of the first embodiment are given the same reference numerals as those components, and will not be described in detail.

The convergence position information calculation unit 210 receives information indicating the subject distance output from the subject distance estimation unit 109, and calculates the convergence position using the subject distance. The convergence position information calculation unit 210 outputs information indicating the calculated convergence position to the convergence angle adjustment unit 211.

The convergence angle adjustment unit 211 receives information indicating the convergence position output from the convergence position information calculation unit 210. The convergence angle adjustment unit 211 aligns the first imaging unit 103 and the second imaging unit 104 in a manner that their relative positions (the relative positions of the optical system 101 and the first imaging unit 103 and the optical system 102 and the second imaging unit 104) correspond to the convergence position (the convergence angle) calculated by the convergence position information calculation unit 210. To enable this, the convergence angle adjustment unit 211 outputs, to the first imaging unit 103, a first convergence angle adjustment signal, which is a control signal for aligning the first imaging unit 103. The convergence angle adjustment unit 211 also outputs, to the second imaging unit 104, a second convergence angle adjustment signal, which is a control signal for aligning the second imaging unit 104.

The convergence angle adjustment unit 211 may perform the processing (1) and (2) for adjusting the relative positions (the convergence angle) of the first imaging unit 103 and the second imaging unit 104.

(1) The optical system 101 and the first imaging unit 103 move in an interlocked manner in accordance with a control signal output from the convergence angle adjustment unit 211, and then the optical system 102 and the second imaging unit 104 move in an interlocked manner in accordance with a control signal output from the convergence angle adjustment unit 211. This adjusts the relative positions (the convergence position (the convergence angle) of the first imaging unit 103 and the second imaging unit 104.

(2) The optical system 101 and the first imaging unit 103 are packed in a single unit, which moves in accordance with a control signal output from the convergence angle adjustment unit 211. The optical system 102 and the second imaging unit 104 are packed in another single unit, which moves in accordance with a control signal output from the convergence angle adjustment unit 211. This adjusts the relative positions (the convergence position (the convergence angle)) of the first imaging unit 103 and the second imaging unit 104.

An image formed by the first imaging unit 103 and an image formed by the second imaging unit 104 are each only required to be obtained at the convergence position (the convergence angle) calculated by the convergence position information calculation unit 210. The physical positional relationship between the first imaging unit 103 and the second imaging unit 104 may not necessarily be the same as the relationship corresponding to the convergence position (the convergence angle) calculated by the convergence position information calculation unit 210. For example, the image obtained by the first imaging unit 103 and the image obtained by the second imaging unit 104 may be identical to images obtained at the convergence position (the convergence angle) calculated by the convergence position information calculation unit 210.

### 2.2 Operation of the Stereo Image Pickup Device

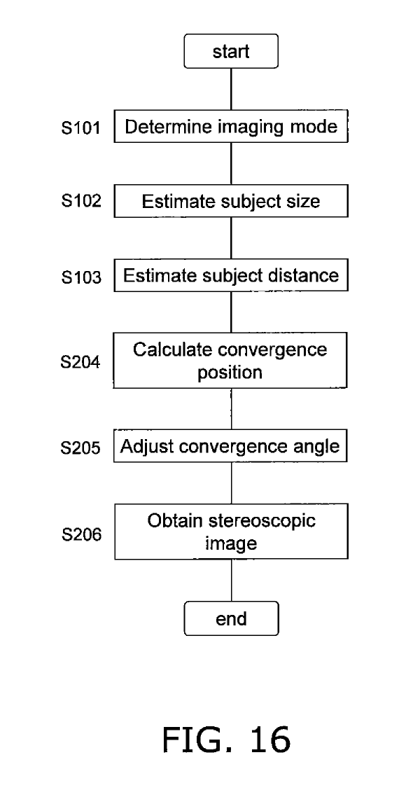

The operation of the stereo image pickup device 2000 with the above-described structure will now be described. FIG. 16 is a flowchart showing the processing corresponding to a stereo image obtaining method implemented by the stereo image pickup device 2000.

### Step S204:

The convergence position information calculation unit 210 calculates the convergence position, which is the point of intersection between the optical axis of the first imaging unit 103 (the optical axis of the optical system 101) and the optical axis of the second imaging unit 104 (the optical axis of the optical system 102) based on a predetermined condition using the subject distance as well as the stereo base information obtained for the first and second imaging units 103 and 104.

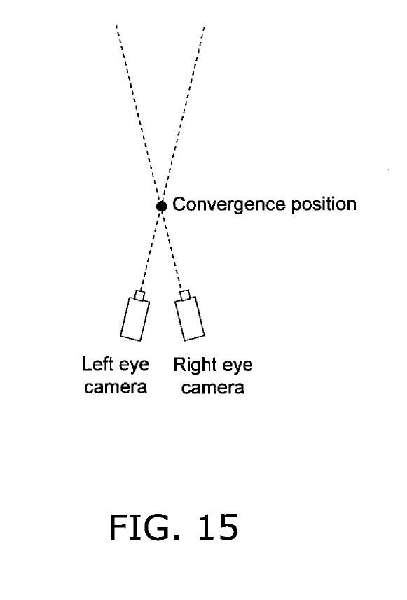

FIG. 15 is a diagram describing the convergence position. As shown in FIG. 15, the intersection between the optical axis of the first imaging unit 103 (the optical axis of the optical system 101) and the optical axis of the second imaging unit 104 (the optical axis of the optical system 102) corresponds to the convergence position. When the subject is at the convergence position, the subject is placed on the virtual screen. The convergence position can be adjusted in a manner that the subject will be placed in front or behind the virtual screen to form a stereo image that can be viewed easily. The convergence position is set to correspond to, for example, the subject distance.

### Step S205:

The convergence angle adjustment unit 211 adjusts the optical axis angle of the first imaging unit 103 (the optical system 101) and the optical axis angle of the second imaging unit 104 (the optical system 102) based on the convergence position information calculated by the convergence position information calculation unit 210. More specifically, the convergence angle adjustment unit 211 calculates the first convergence angle adjustment signal and the second convergence angle adjustment signal in a manner that the first image signal and the second image signal will be image signals obtained at the convergence position calculated by the convergence position information calculation unit 210 based on the convergence position information calculated by the convergence position information calculation unit 210. The convergence angle adjustment unit 211 outputs the first convergence angle adjustment signal to the first imaging unit 103, and outputs the second convergence angle adjustment signal to the second imaging unit 104.

In the stereo image pickup device 2000, the optical system 101 and the first imaging unit 103 may be aligned in an interlocked manner in accordance with the first convergence angle adjustment signal. Also, in the stereo image pickup device 2000, the optical system 102 and the second imaging unit 104 may be aligned in an interlocked manner in accordance with the second convergence angle adjustment signal.

The first imaging unit 103 adjusts the position (the convergence position (the convergence angle)) based on the first convergence angle adjustment signal output from the convergence angle adjustment unit 211. The second imaging unit 104 adjusts the position (the convergence position (the convergence angle)) based on the second convergence angle adjustment signal output from the convergence angle adjustment unit 211.

### Step S206:

After the adjustment of the convergence position (the convergence angle), each of the first imaging unit 103 and the second imaging unit 104 images the subject to obtain an image (a stereo image) at the convergence position (the convergence angle) calculated by the convergence position information calculation unit 210.

The image signals generated by the first imaging unit 103 and the second imaging unit 104 are then processed through the camera processing performed by the camera signal processing unit 105, and recorded as stereo image data by the image recording unit 106.

### Outline of Second Embodiment

As described above, the stereo image pickup device 2000 estimates the subject size in accordance with the imaging mode, and estimates the distance to the subject using the estimated subject size and the focal length. The stereo image pickup device 2000 further calculates the convergence position corresponding to an optimum disparity (for example a disparity falling within the stereoscopic-viewing enabling area) using the distance to the subject, and determines the convergence angle based on the calculated convergence position. The stereo image pickup device 2000 adjusts the optical axes of the two imaging units (the first imaging unit 103 (the optical system 101) and the second imaging unit 104 (the optical system 102), and obtains a stereo image using the two imaging units (the first imaging unit 103 and the second imaging unit 104). When this stereo image is displayed on a display device, the image will have an appropriate disparity on the virtual screen (on the display screen of the display device). As a result, the displayed stereo image will have an appropriate stereoscopic effect. In this manner, the above processing enables the stereo image pickup device 2000 to perform stereoscopic imaging having an appropriate stereoscopic effect.

Although the above embodiment describes the case in which the stereo image pickup device 2000 determines an optimum disparity based on a disparity that falls within the stereoscopic-viewing enabling area, the present invention should not be limited to this structure. For example, the stereo image pickup device 2000 may determine an optimum disparity based on a reference value for enabling a predetermined object to have an optimum stereoscopic effect (e.g., reproduce appropriate unevenness in the object surface by preventing the cardboard effect).

The first imaging unit 103 and the second imaging unit 104 each are an example of the imaging unit.

The subject size estimation unit 108 is an example of the obtaining unit.

The subject distance estimation unit 109 is an example of the estimation unit.

The convergence position information calculation unit 210 and the convergence angle adjustment unit 211 each are an example of the adjustment unit.

The imaging mode selection unit 107 is an example of the setting unit.

The subject size estimation unit 108 can store information showing the correspondence between the imaging mode and the estimated subject size shown in FIG. 5. The subject size estimation unit 108 can thus function as the storage unit.

The subject distance estimation unit 109 detects an image area corresponding to the subject being imaged using a through image output from the camera signal processing unit 105. The subject distance estimation unit 109 can thus function as the detection unit.

### Modifications

Modifications of the present embodiment will now be described.

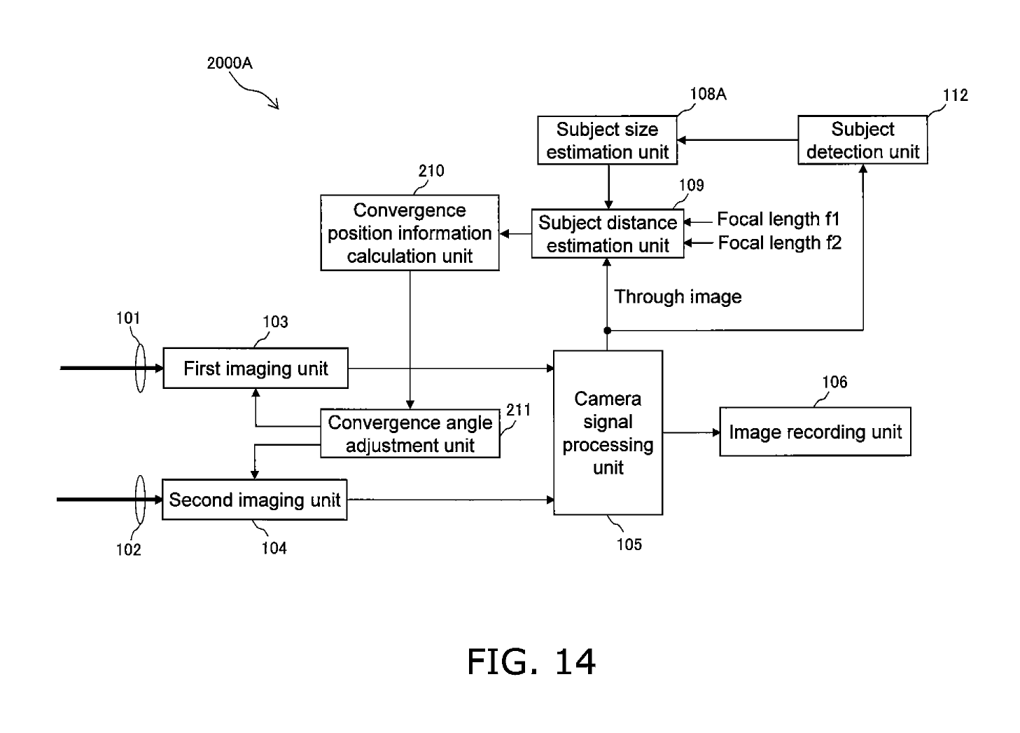

FIG. 14 schematically shows the structure of a stereo image pickup device 2000A according to a modification of the present embodiment.

As shown in FIG. 14, the stereo image pickup device 2000A according to the modification has the same structure as the stereo image pickup device 1000A according to the modification of the first embodiment except that it includes (1) a convergence position information calculation unit 210 instead of the stereo base information calculation unit 110, and (2) a convergence angle adjustment unit 211 instead of the stereo base adjustment unit 111.

The stereo image pickup device 2000A according to this modification uses the convergence angle as the imaging parameter to be adjusted, whereas the stereo image pickup device 1000A according to the modification of the first embodiment uses the stereo base as the imaging parameter to be adjusted. The operation of the stereo image pickup device 2000A according to this modification differs from the operation of the stereo image pickup device 1000A only in the imaging parameter to be adjusted by the stereo image pickup device 2000A.

In the same manner as the stereo image pickup device 1000A according to the modification of the first embodiment, the stereo image pickup device 2000A of the present modification may also detect an image area forming a specific subject, and use data about the specific subject registered in advance to increase the estimation precision of the subject distance further. As a result, the stereo image pickup device 2000A according to the present modification sets the imaging parameter (for example, the convergence angle) used in stereoscopic imaging based on the subject distance estimated with a higher precision. This enables the stereo image pickup device 2000A to obtain a stereo image (a three-dimensional image) that can reproduce a natural stereoscopic effect (a natural depth) when the image is viewed.

### Other Embodiments

Although the above embodiments describe the case in which the two imaging units (the first imaging unit 103 and the second imaging unit 104) are used to obtain (form) a stereo image (a left eye image and a right eye image), the present invention should not be limited to this structure. For example, the stereo image pickup device of each of the above embodiments may use only a single image sensor (an imaging unit) to alternately obtain a left eye image and a right eye image in a time divided manner. Alternatively, the stereo image pickup device of each of the above embodiments may use a single imaging unit whose imaging surface is divided into two areas, with which a left eye image and a right eye image are obtained respectively. Alternatively, the stereo image pickup device of each of the above embodiments may include a mechanism for optically switching between an optical path on which the subject light travels from the first point and an optical path on which the subject light travels from the second point to obtain a left eye image and a right eye image using a single imaging unit.

In the second embodiment, the stereo image pickup device 2000 may further include an imaging surface shift adjustment unit instead of the convergence angle adjustment unit 211. The imaging surface shift adjustment unit adjusts the convergence position by shifting the imaging surface of the first imaging unit 103 and/or the imaging surface of the second imaging unit 104 based on the convergence position information calculated by the convergence position information calculation unit 210. The stereo image pickup device 2000 may adjust the convergence position using the imaging surface shift adjustment unit.

In the second embodiment, the stereo image pickup device 2000 may further include an imaging surface area extraction unit. The imaging surface area extraction unit adjusts the convergence position by reading image data corresponding to a predetermined area on the imaging surface of the first imaging unit 103 and/or the second imaging unit 104 based on the convergence position information calculated by the convergence position information calculation unit 210. The stereo image pickup device 2000 may adjust the convergence position using the imaging surface area extraction unit.

In the above embodiments, the right component and the left component (the first point (corresponding for example to the left point) and the second point (corresponding for example to the right point) or the image obtained at the first point (corresponding for example to the left eye image) and the image obtained at the second point (corresponding for example to the right eye image)) should not necessarily be limited to the right-left correspondence described in the above embodiments. The right component and the left component may be switched without departing from the scope and spirit of the invention.

Each block of the stereo image pickup device described in the above embodiments may be formed using a single chip with a semiconductor device, such as LSI (large-scale integration), or some or all of the blocks of the stereo image pickup device may be formed using a single chip.

Although LSI is used as the semiconductor device technology, the technology may be IC (integrated circuit), system LSI, super LSI, or ultra LSI depending on the degree of integration of the circuit.

The circuit integration technology employed should not be limited to LSI, but the circuit integration may be achieved using a dedicated circuit or a general-purpose processor. A field programmable gate array (FPGA), which is an LSI circuit programmable after manufactured, or a reconfigurable processor, which is an LSI circuit in which internal circuit cells are reconfigurable or more specifically the internal circuit cells can be reconnected or reset, may be used.

Further, if any circuit integration technology that can replace LSI emerges as an advancement of the semiconductor technology or as a derivative of the semiconductor technology, the technology may be used to integrate the functional blocks. Biotechnology is potentially applicable.

The processes described in the above embodiments may be implemented using either hardware or software (which may be combined together with an operating system (OS), middleware, or a predetermined library), or may be implemented using both software and hardware. When the stereo image pickup device of each of the above embodiments is implemented by hardware, the stereo image pickup device requires timing adjustment for its processes. For ease of explanation, the timing adjustment associated with various signals required in an actual hardware design is not described in detail in the above embodiments.

The processes described in the above embodiments may not be performed in the order specified in the above embodiments. The order in which the processes are performed may be changed without departing from the scope and spirit of the invention.

The present invention may also include a computer program enabling a computer to implement the method described in the above embodiments and a computer readable recording medium on which such a program is recorded. The computer readable recording medium may be, for example, a flexible disk, a hard disk, a CD-ROM, an MO, a DVD, a DVD-ROM, a DVD-RAM, a Blu-ray disc, or a semiconductor memory.

The computer program should not be limited to a program recorded on the recording medium, but may be a program transmitted with an electric communication line, a radio or cable communication line, or a network such as the Internet.

The specific structures described in the above embodiments are mere examples of the present invention, and may be changed and modified variously without departing from the scope and spirit of the invention.

### INDUSTRIAL APPLICABILITY

The image pickup device, the image pickup method, the program, and the integrated circuit of the present invention can be used for digital cameras and digital video cameras with stereoscopic imaging capabilities to form a stereo image having an appropriate stereoscopic effect. The present invention is therefore implementable in the field of imaging.

### REFERENCE SIGNS LIST

1000, 1000A, 2000, 2000A stereo image pickup device
101 first optical system
102 second optical system
103 first imaging unit
104 second imaging unit
105 camera signal processing unit
106 image recording unit
107 imaging mode selection unit
108 subject size estimation unit
109 subject distance estimation unit
110 stereo base information calculation unit
111 stereo base adjustment unit
210 convergence position information calculation unit
211 convergence angle adjustment unit

1. An image pickup device that forms a stereo image, comprising:
an imaging unit configured to image a subject and obtain a first point image corresponding to a scene including the subject viewed from a first point and a second point image corresponding to a scene including the subject viewed from a second point, the second point being different from the first point;
an obtaining unit configured to obtain subject size information using information that is based on image data forming the first point image and the second point image or information that is based on settings used in forming the first point image and the second point image, the subject size information indicating a size of the subject;
an estimation unit configured to estimate a subject distance using the subject size information, the subject distance being a distance from the image pickup device to the subject; and
an adjustment unit configured to adjust an imaging parameter used by the imaging unit in a manner to change a disparity determined by the first point image and the second point image based on at least information indicating the subject distance estimated by the estimation unit.

2. The image pickup device according to claim 1, further comprising:
a setting unit configured to set an imaging mode selected from a plurality of different imaging modes; and
a storage unit storing a plurality of sets of subject size information and the plurality of imaging modes in a manner that each set of subject size information indicating a size of a different subject corresponds to a different one of the imaging modes,
wherein the obtaining unit obtains, from the plurality of sets of subject size information stored in the storage unit, a set of subject size information corresponding to the imaging mode set by the setting unit.

3. The image pickup device according to claim 1, further comprising:
a detection unit configured to detect an image area including the subject using at least one of the first point image and the second point image,
wherein the obtaining unit obtains the subject size information based on information indicating the imaging area detected by the detection unit.

4. The image pickup device according to claim 3, wherein
the detection unit detects the image area including the subject by detecting an image area forming a face of a person.

5. The image pickup device according to claim 1, wherein
the estimation unit estimates the subject distance based on information indicating a vertical size of the first point image and a vertical size of the second point image, information indicating a focal length used in forming the first point image and a focal length used in forming the second point image, and the subject size information.

6. The image pickup device according to claim 1, wherein
at least one of an initial focal length, an initial stereo base, and an initial convergence angle is used as the imaging parameter in accordance with the imaging mode set when the image pickup device is activated.

7. The image pickup device according to claim 1, wherein
the adjustment unit calculates a stereo base that corresponds to a target relative position determined by the first point and the second point by using the subject distance, a viewing distance that is a distance between a viewer and a display device for displaying the first point image and the second point image when the first point image and the second point image are viewed, and a target disparity set for the subject, and adjusts a stereo base of the imaging unit based on the calculated stereo base.

8. The image pickup device according to claim 7, further comprising:
a warning information display unit configured to display warning information for a user when the stereo base of the imaging unit is not adjustable based on the stereo base calculated by the adjustment unit.

9. The image pickup device according to one of claims 7 and 8, further comprising:
an information providing unit configured to provide a user with information indicating the stereo base calculated by the adjustment unit.

10. The image pickup device according to claim 7, further comprising:
a display unit configured to provide a user with predetermined information,
wherein the imaging unit includes a first imaging unit that obtains the first point image corresponding to the scene including the subject viewed from the first point and a second imaging unit that obtains the second point image corresponding to the scene including the subject viewed from the second point different from the first point,
the imaging unit performs imaging in a twin-lens imaging mode in which a stereo image is obtained using both the first imaging unit and the second imaging unit when the stereo base of the imaging unit is adjustable based on the stereo base calculated by the adjustment unit, and
the imaging unit performs imaging in a double-shooting imaging mode in which a stereo image is obtained by performing imaging at least twice while the stereo image pickup device is being slid in a substantially horizontal direction when the stereo base of the imaging unit is not adjustable based on the stereo base calculated by the adjustment unit, and
when the imaging unit performs imaging in the twin-lens imaging mode, the adjustment unit adjusts the imaging parameter based on the stereo base before a stereo image is obtained using the first point image and the second point image that are obtained by the first imaging unit and the second imaging unit, and
when the imaging unit performs imaging in the double-shooting imaging mode, the display unit performs a display urging the double-shooting imaging mode.

11. The image pickup device according to claim 1, wherein
the adjustment unit calculates a convergence position that is a point of intersection between an optical axis of a first optical system and an optical axis of a second optical system by using the subject distance, a viewing distance that is a distance between a viewer and a display device for displaying the first point image and the second point image when the first point image and the second point image are viewed, and a target disparity set for the subject, and adjusts a convergence position of the imaging unit based on the calculated convergence position.

12. The image pickup device according to claim 11, further comprising:
a warning information display unit configured to display warning information for a user when the convergence position of the imaging unit is not adjustable based on the convergence position calculated by the adjustment unit.

13. The image pickup device according to claim 11, further comprising:
an information providing unit configured to provide a user with information indicating the convergence position calculated by the adjustment unit.

14. The image pickup device according to claim 7, wherein
the adjustment unit sets, as the target disparity, a disparity defined in an area that enables the first point image and the second point image to be fused into a stereo image of the subject when the first point image and the second point image are viewed by a viewer.

15. The image pickup device according to claim 7, further comprising:
an image recording unit configured to record the first point image and the second point image,
wherein the image recording unit records the first point image and the second point image obtained by the imaging unit after the adjustment unit adjusts the imaging parameter.

16. An image pickup method used by an image pickup device that forms a stereo image, the image pickup device including an imaging unit configured to image a subject and obtain a first point image corresponding to a scene including the subject viewed from a first point and a second point image corresponding to a scene including the subject viewed from a second point different from the first point, the method comprising:
obtaining subject size information using information that is based on image data forming the first point image and the second point image or information that is based on settings used in forming the first point image and the second point image, the subject size information indicating a size of the subject;
estimating a subject distance using the subject size information, the subject distance being a distance from the image pickup device to the subject; and
adjusting an imaging parameter used by the imaging unit in a manner to change a disparity determined by the first point image and the second point image in accordance with at least information indicating the subject distance estimated by the step of estimating.

17. A non-transitory computer-readable recording medium storing thereon a program that is executed by a computer to enable an image pickup device that forms a stereo image to implement an image pickup method, the image pickup device including an imaging unit configured to image a subject and obtain a first point image corresponding to a scene including the subject viewed from a first point and a second point image corresponding to a scene including the subject viewed from a second point different from the first point, the method comprising:
obtaining subject size information using information that is based on image data forming the first point image and the second point image or information that is based on settings used in forming the first point image and the second point image, the subject size information indicating a size of the subject;
estimating a subject distance using the subject size information, the subject distance being a distance from the image pickup device to the subject; and
adjusting an imaging parameter used by the imaging unit in a manner to change a disparity determined by the first point image and the second point image in accordance with at least information indicating the subject distance estimated by the step of estimating.

18. An integrated circuit used in an image pickup device that forms a stereo image, the image pickup device including an imaging unit configured to image a subject and obtain a first point image corresponding to a scene including the subject viewed from a first point and a second point image corresponding to a scene including the subject viewed from a second point different from the first point, the integrated circuit comprising:
an obtaining unit configured to obtain subject size information using information that is based on image data forming the first point image and the second point image or information that is based on settings used in forming the first point image and the second point image, the subject size information indicating a size of the subject;
an estimation unit configured to estimate a subject distance using the subject size information, the subject distance being a distance from the image pickup device to the subject; and
an adjustment unit configured to adjust an imaging parameter used by the imaging unit in a manner to change a disparity determined by the first point image and the second point image in accordance with at least information indicating the subject distance estimated by the estimation unit.
